(19) United States
(12) Patent Application Publication
(10) Pub. No.: US 2017/0350101 A1
(43) Pub. Date: Dec. 7, 2017

(54) INTELLIGENT SHOWER SYSTEM AND METHODS

(71) Applicant: Livin Life Inc., Santa Clara, CA (US)

(72) Inventors: Jaejun LEE, Seoul (KR); Seokwoo LEE, Seoul (KR)

(21) Appl. No.: 15/615,762

(22) Filed: Jun. 6, 2017

Related U.S. Application Data
(60) Provisional application No. 62/346,837, filed on Jun. 7, 2016.

(51) Int. Cl. E03C 1/04; A47K 3/28; G05B 19/04

(52) U.S. Cl. CPC E03C 1/041; A47K 3/28; G05B 19/04; E03C 2001/0418

(57) ABSTRACT

Disclosed herein relates to a field of an intelligent shower system, and more particularly, to a shower control system and methods of installation, driving, control, display, and learning associated with the shower control system. In some embodiments, the shower control system includes: (i) a valve control assembly configured to control one or more valves of a shower system, and (ii) a shower output assembly having an inlet and an outlet, the shower output assembly configured to receive through the inlet a water flow and discharging through the outlet at least a portion of the water flow. Controlling the one or more valves adjusts a temperature of a water output for the shower system. The shower output assembly includes a temperature sensor configured to determine a temperature of the received water flow or the discharged water flow.

### RELATED APPLICATIONS

This application claims the benefit of, and priority to, U.S. Provisional Patent Application Ser. No. 62/346,837, filed Jun. 7, 2016, which is incorporated by reference herein in its entirety. This application is related to U.S. patent application Ser. No. ______ (Attorney Docket No. 119223-5002-US), entitled “Intelligent Shower System and Methods for Providing Recommended Temperature” and U.S. patent application Ser. No. ______ (Attorney Docket No. 119223-5003-US), entitled “Intelligent Shower System and Methods for Providing Automatically-Updated Shower Recipe,” both of which are filed concurrently herewith. Both of these applications are incorporated by reference herein in their entireties.

### TECHNICAL FIELD

Embodiments disclosed herein relate to a field of an intelligent shower system, and more particularly, to an intelligent shower system used for a shower and/or outputting water for other purposes, and methods of installation, driving, control, display, and learning associated with the intelligent shower system.

### BACKGROUND

A shower system used at home generally receives hot water and cold water and a user sets the desired water pressure and water temperature by manually rotating a valve.

Such a shower system has a mechanical structure that may vary depending on countries. For example, in U.S.A., the water pressure and the water temperature in a typical system are set by adjusting a single-axis valve. For example, the hot water and the cold water are supplied from two directions, and the user manually turns the valve receiving the hot water and the cold water in one direction, so that a water output follows the sequence of: (i) no water supply, (ii) cold water supply, and (iii) hot water supply.

Meanwhile, in Japan, Korea and the like, the water pressure and the water temperature can be simultaneously controlled by a two-axis valve. The water temperature is determined by rotating the valve left and right, and the water pressure is determined by rotating the valve up and down.

In the manual shower system described above, the user controls the valve and waits until the desired water pressure and water temperature is reached, and then takes a shower. However, when it is determined that the water pressure and water temperature are not at the desired levels, the user has to make additional adjustments, which is an inconvenience to the user.

### SUMMARY OF THE INVENTION

An objective of the present invention is to provide an intelligent shower system (and/or an intelligent shower control system) used for a shower and/or outputting water for other purposes, and methods of installation, driving, control, display, and learning associated with the intelligent shower system (and/or an intelligent shower control system).

Hereinafter, some features are briefly described without limiting the scope of the invention defined by the claims. Those skilled in the art will comprehend the advantageous features of systems, methods, and devices described herein based on the following description and Detailed Description of the Invention.

In some embodiments, a shower control system includes a valve control assembly configured to control one or more valves of a shower system. Controlling the one or more valves adjusts a temperature of a water output for the shower system. The shower control system further includes a shower output assembly having an inlet and an outlet. The shower output assembly is configured to: (i) receive, through the inlet, a water flow, and (ii) discharge, through the outlet, at least a portion of the water flow. The shower output assembly includes a temperature sensor configured to determine a temperature of the received water flow or the discharged water flow.

In some embodiments, a shower control system for controlling a temperature of water by controlling a mixing valve of a water supply system installed in a building includes: a shower valve module for controlling the temperature of the water output from the mixing valve by adjusting a mixing shaft of the mixing valve; and a shower head module for receiving the water output from the mixing valve, discharging the water to an outside, and controlling a flow rate of the water.

In some embodiments, the shower head module controls the flow rate of the water according to a control signal received from the shower valve module, and the shower valve module is able to communicate with an external device.

In some embodiments, the shower control system further includes an adapter plate module having one side fixed to a wall surface where the mixing valve is installed and an opposite side coupled to the shower valve module.

In some embodiments, the adapter plate module includes: a wall attachment unit fixed to the wall surface; and a shower valve module coupling unit extending and protruding from the wall attachment unit.

In some embodiments, the shower valve module is formed at one surface thereof with a coupling hole for receiving the shower valve module coupling unit.

In some embodiments, the wall attachment unit is formed therein with a through-hole and the mixing valve is exposed to the outside by passing through the through-hole.

In some embodiments, the adapter plate module further includes: a coupler coupled to the mixing shaft; and a support bracket for rotatably supporting the coupler. The coupler has a shape of a pipe having a through-hole partially or entirely formed in the pipe.

In some embodiments, the support bracket includes: a bracket body formed therein with a through-hole for receiving the coupler; and a bracket leg extending and protruding from the bracket body. The coupler is rotatably supported by the through-hole of the bracket body, and the wall attachment unit includes a concave part or a perforation part for receiving the bracket leg.

In some embodiments, the shower valve module includes: an actuator for supplying torque; a torque transfer assembly for directly or indirectly transferring the torque supplied from the actuator to the mixing shaft; a shower microcontroller unit (MCU) for controlling an operation of the actuator; and a valve communication module that communicates with an external device.

In some embodiments, the valve communication module includes: a first valve communication module for communicating with the shower head module; and a second valve communication module for communicating with a user terminal. The first valve communication module and the second valve communication module make communication in mutually different schemes, and the first valve communication module has a communication scheme representing power consumption less than power consumption of a communication scheme of the second valve communication module.

In some embodiments, the shower MCU determines a desired temperature of water based on an input from a user terminal, an input to a control panel provided on the shower valve module, or a scheduled shower pattern received from the user terminal or a service server, the shower MCU receives an actual temperature of water, which flows inside the shower head module, from the shower head module, and the shower MCU generates an operation signal for the actuator to reduce a difference between the actual temperature and the desired temperature.

In some embodiments, the shower MCU measures a reaction rate of the water having the actual temperature received from the shower head module and flowing inside the shower head module according to the operation of the actuator and learns the measured reaction rate, and the shower MCU generates the operation signal for the actuator based on the learned reaction rate, the actual temperature, and the desired temperature.

In some embodiments, the torque transfer assembly includes: an actuator gear coupled to an output rotary shaft of the actuator; a knob gear engaged with the actuator gear; and a coupler coupling part coupled to the knob gear and having a rod shape formed therein with a through-hole. The torque of the actuator is transferred to the mixing shaft through the actuator gear and the knob gear.

In some embodiments, the shower valve module further includes a knob manually operated by a user, the torque transfer assembly further includes a knob coupling part, and the knob coupling part has one end coupled to the knob and an opposite end coupled to the coupler coupling part. When the user manually rotates the knob, torque applied to the knob by the user is transferred to the knob coupling part, the torque transferred to the knob coupling part is transferred to the coupler coupling part, and the torque transferred to the coupler coupling part is transferred to the mixing shaft.

In some embodiments, the shower MCU receives information on the manual rotation of the knob and stops the operation of the actuator when the user manually rotates the knob.

In some embodiments, the shower control system further includes an adapter plate module having one side fixed to a wall surface where the mixing valve is installed and an opposite side coupled to the shower valve module. The adapter plate module includes: a coupler coupled to the mixing shaft; and a support bracket for rotatably supporting the coupler. The coupler coupling part is coupled to the coupler.

In some embodiments, the shower head module includes: a shower head coupling part coupled to a shower head; a head pipe coupling part coupled to a head pipe through which the water mixed by the mixing valve is supplied; a pipe assembly; a flow rate control module for controlling a flow rate of the water flowing inside the pipe assembly; a head communication module for communicating with the shower valve module; and a head MCU for controlling operations of the flow rate control module and the head communication module.

In some embodiments, the shower head module further includes: a head battery for supplying power to the flow rate control module, the head communication module, and the head MCU; and an energy generator for producing electric energy by the water flowing inside the pipe assembly. In some embodiments, the head battery is a rechargeable battery, and the electric energy produced by the energy generator is supplied to the head battery. In some embodiments, the head battery includes a capacitor. In some embodiments, the head battery is a capacitor (e.g., the head battery does not include any electrochemical cells).

In some embodiments, the shower head module further includes a temperature sensor for directly or indirectly sensing the temperature of the water flowing inside the pipe assembly. Temperature data sensed by the temperature sensor is transmitted to the shower valve module.

In some embodiments, the pipe assembly includes: a first pipe having one end coupled to the head pipe coupling part; a second pipe directly or indirectly coupled to the first pipe; and a third pipe directly or indirectly coupled to the second pipe. At least one of the first pipe, the second pipe, and the third pipe includes at least one bent portion for changing a proceeding direction of a flow path, in which a sum of bending angles of the at least one bent portion is substantially 360 degrees.

In some embodiments, the first pipe includes one bent portion substantially bent by 90 degrees, the second pipe includes two bent portions substantially bent by 90 degrees, respectively, and the third pipe includes one bent portion substantially bent by 90 degrees, an energy generator is disposed between the first pipe and the second pipe, and the flow rate control module is disposed between the second pipe and the third pipe.

In some embodiments, the head MCU controls the flow rate control module according to a control instruction received from the shower valve module, and the shower valve module determines whether the temperature sensed by the shower head module is close to a desired temperature or not, and transmits an instruction for opening the flow rate control module when the temperature sensed by the shower head module is determined to be close to the desired temperature.

In some embodiments, the head MCU monitors a battery charging level of the head battery, and controls to completely open the flow rate control module when the battery charging level is determined to be lower than a preset reference value.

### BRIEF DESCRIPTION OF THE DRAWINGS

Embodiments will be described with reference to the following drawings. The following drawings do not limit the present invention, but are provided as examples. Like reference numerals refer to identical or functionally similar elements.

FIG. 1 illustrates a structure of a shower system including a shower control system according to some embodiments.

FIG. 2 schematically illustrates a configuration of a user terminal according to some embodiments.

FIG. 3 schematically illustrates a shower system, including a shower control system, in terms of a network according to some embodiments.

FIG. 4 schematically illustrates a configuration of a service server according to some embodiments.

FIG. 5 schematically illustrates an electronic configuration of a shower head module and a shower valve module according to some embodiments.

FIG. 6 illustrates a flowchart of a temperature control operation in the shower control system according to some embodiments.

FIG. 7 illustrates a flowchart of a control operation in the shower control system according to some embodiments.

FIG. 8 schematically illustrates an installation configuration of the shower control system according to some embodiments.

FIG. 9 schematically illustrates an adapter plate module according to some embodiments.

FIG. 10 schematically illustrates the adapter plate module according to some embodiments.

FIG. 11 schematically illustrates an installation configuration of the shower valve module installed on a wall surface through the adapter plate module, when viewed from the front, according to some embodiments.

FIG. 12 schematically illustrates, when viewed from the back, a configuration of the shower valve module coupled with the adapter plate module according to some embodiments.

FIG. 13 schematically illustrates an internal structure of the shower valve module according to some embodiments.

FIG. 14 schematically illustrates internal mechanical driving elements of the shower valve module according to some embodiments.

FIG. 15 is a front perspective view of the shower head module according to some embodiments.

FIG. 16 is a rear perspective view of the shower head module according to some embodiments.

FIG. 17 schematically illustrates an internal configuration of the shower head module according to some embodiments.

FIG. 18 is a perspective view illustrating the internal configuration of the shower head module according to some embodiments.

FIG. 19 is a flowchart showing the operation of the shower control system according to some embodiments.

### DETAILED DESCRIPTION OF THE INVENTION

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

Devices or programs that are in communication with one another need not be in continuous communication with each other unless expressly specified otherwise. In addition, devices or programs that are in communication with one another communicate directly or indirectly through one or more intermediaries.

Embodiments discussed below describe, in part, distributed computing solutions that manage all or part of a communicative interaction between network elements. In this context, a communicative interaction is intending to send information, sending information, requesting information, receiving information, receiving a request for information, or any combination thereof. In this manner, a communicative interaction could be unidirectional, bidirectional, multi-directional, or any combination thereof. In some circumstances, a communicative interaction could be relatively complex and involve two or more network elements.

For example, a communicative interaction is “a conversation” or series of related communications between a client and a server—each network element sending and receiving information to and from the other. The communicative interaction between the network elements is not necessarily limited to only one specific form. A network element is a node, a piece of hardware, software, firmware, middleware, another component of a computing system, or any combination thereof.

According to the present invention, the shower control system and the shower system including the same, or any combination thereof include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes.

For example, the shower system including the shower control system includes any combination of a shower valve module, a shower head module, a user terminal, a personal computer, a PDA, a consumer electronic device, a media device, a smart phone, a cellular or mobile phone, a smart utility meter, an advanced metering infrastructure, a smart energy device, an energy display device, a home automation controller, an energy hub, a water supply system, a set-top box, a digital media subscriber system, a cable modem, a fiber optic enabled communication device, a media gateway, a home media management system, a network server or storage device, a smart appliance, an HVAC system, an Internet router, a switch router, a wireless router, or other network communication device, or any other suitable device or system, and can vary in size, shape, performance, functionality, and price.

In some embodiments, the shower control system or the shower system including the shower control system includes a memory, one or more processing resources or controllers such as a central processing unit (CPU) or hardware or software control logic. In some embodiments, additional components of the shower control system or the shower system including the shower control system include one or more storage devices, one or more wireless, wired or any combination thereof of communication ports to communicate with external devices as well as various input and output (I/O) devices, such as a keyboard, a mouse, pointers, controllers, and display devices. In some embodiments, the shower control system also includes one or more buses operable to transmit communications between the various hardware components, and communicates using wireline communication data buses, wireless network communication, or any combination thereof.

As used herein, a wireless energy network includes various types and variants of commercially available wireless communication (e.g., using short-wave communication signals) including, but not limited to, any combination or portion of IEEE 802.15-based wireless communication, Zigbee communication, INSETEON communication, X10 communication protocol, Z-Wave communication, Bluetooth communication, WI-FI communication, IEEE 802.11-based communication, WiMAX communication, IEEE 802.16-based communication, various proprietary wireless communications, or any combination thereof.

As described herein, a flowcharted technique, method, or algorithm is described in a series of sequential actions. Unless expressly stated to the contrary, the sequence of the actions and the party performing the actions may be freely changed without departing from the scope of the teachings. Actions may be added, deleted, or altered in several ways.

Similarly, in some embodiments, the actions are re-ordered or looped. Further, although processes, methods, algorithms or the like may be described in a sequential order, such processes, methods, algorithms, or any combination thereof are operable to be performed in alternative orders. Further, in some embodiments, some actions within a process, method, or algorithm are performed simultaneously during at least a point in time (e.g., actions performed in parallel), and are also performed in whole, in part, or any combination thereof.

As used herein, the terms “comprises,” “comprising,” “includes,” “including,” “has,” “having,” or any other variation thereof, are intended to cover a non-exclusive inclusion. For example, a process, method, article, system, or apparatus that comprises a list of features is not necessarily limited only to those features but can include other features not expressly listed or inherent to such process, method, article, system, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single device is described herein, more than one device may be used in place of a single device. Similarly, where more than one device is described herein, a single device may be substituted for that one device.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification including definitions will control. In addition, the materials, methods, and examples are illustrative only and not intended to be limiting.

To the extent not described herein, many details regarding specific materials, processing acts, and circuits are conventional.

As used herein, “a shower system” indicates a system that is involved in supplying water at home or other commercial buildings. For convenience, the following description will be made with reference to, but not limited to, a shower system provided in a restroom at home, and includes a shower control system capable of controlling temperature and/or flow rate of a water output.

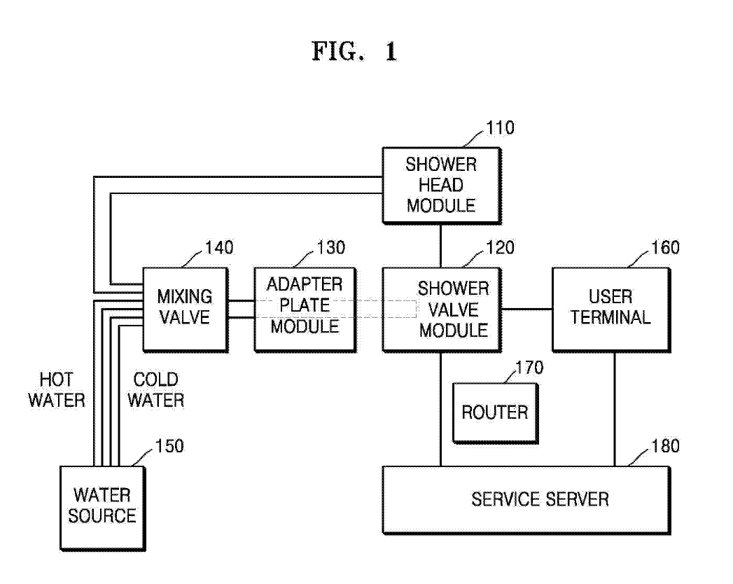

FIG. 1 illustrates a structure of a shower system including a shower control system according to some embodiments.

The shower system includes: a water source 150 for supplying hot water and/or cold water; a mixing valve 140 for supplying the water from the water source 150 to a shower head module 110 (an example of a shower output assembly) and adjusting an amount of the water (e.g., adjusting the amount of hot water and/or the amount of the cold water); a shower valve module 120 (an example of a valve control assembly) for mechanically adjusting the mixing valve 140; an adapter plate module 130 positioned between the mixing valve 140 and the shower valve module 120 to facilitate mounting the shower valve module 120 on a wall; a shower head module 110 for adjusting a flow rate of the water from the mixing valve 140 while supplying the water to a user; a user terminal 160 for transmitting data to and receiving data from the shower valve module 120; a service server 180 for transmitting data to and receiving data from the user terminal 160 and/or the shower valve module 120; and a router 170 for selectively relaying communications between the shower valve module 120 and the service server 180, or processing data.

In some embodiments, the shower control system includes the shower valve module 120 (e.g., the valve control assembly) and the shower head module 110 (e.g., the shower output assembly). In some embodiments, the shower control system further includes the adapter plate module 130. In some embodiments, the shower control system further includes at least one of the user terminal 160, the router 170, the service server 180, and the water source 150, in addition to the shower valve module 120, the shower head module 110, and the adapter plate module 130.

In some embodiments, the water source 150 supplies cold and hot water. The mixing ratio of the cold water and hot water supplied as described above is controlled by the mixing valve 140, so that water having the temperature desired by the user is supplied to the shower head module 110.

In the related art, a knob protruding from the mixing valve 140 is manually operated by the user to adjust the flow rate and temperature of the water.

However, in some embodiments, the user does not directly control the knob, but performs an input on the flow rate and/or temperature directly to the shower valve module 120, or an input on the flow rate and/or temperature through the user terminal 160. Accordingly, the mixing valve 140 is controlled in a controller of the shower valve module 120 (e.g., a valve controller), so that the temperature and flow rate of the water supplied to the shower head module 110 is automatically controlled. It should be noted that the embodiments described herein apply to various valve assemblies (e.g., a valve assembly with one single-axis valve, such as the ones used with a single handle system; a valve assembly with one two-axis valve, such as a single-handle ball valve; and a valve assembly with two single-axis valves, such as the ones used for a shower system having two distinct handles (e.g., a first handle for cold water and a second handle for hot water)).

In some embodiments, the shower valve module 120 controls the mixing valve 140 according to a scheduled shower pattern or the flow rate and/or the temperature, which is calculated without a real-time input of the user, or a scheduled shower pattern or the flow rate and/or the temperature, which is received from the user terminal 160 or the service server 180.

Meanwhile, information sensed by the shower valve module 120 and the shower head module 110 is transmitted to the user terminal 160 and/or the service server 180. Then, the user terminal 160 and/or the service server 180 calculates an automatic shower schedule or information on the recommended temperature and/or flow rate based on the received information, and then transmits the calculated schedule or information to the shower valve module 120.

In addition, in some embodiments, the service server 180 collects the information that is received from a plurality of users and sensed by the shower valve module 120 and/or the shower head module 110, and generates new information through the collected information. The new information is transmitted to the user terminal 160 and the shower valve module 120 so as to be utilized when using the shower control system.

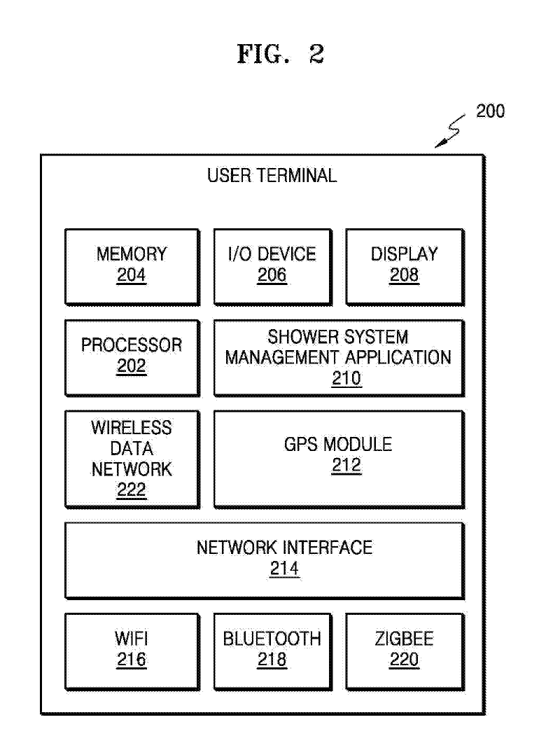

FIG. 2 schematically illustrates a configuration of a user terminal according to some embodiments.

In some embodiments, the user terminal 200 corresponds to a remote controller, a smart phone, a tablet, a personal computer (PC; hereinafter referred to as “PC”), a mobile phone, a video phone, an e-book reader, a desktop PC, a laptop PC, a Netbook PC, a personal digital assistant (PDA; hereinafter referred to as “PDA”), a portable multimedia player (PMP; hereinafter referred to as “PMP”), an MP3 player, a mobile medical device, a camera, a wearable device (for example, a head-mounted device (HMD; hereinafter referred to as “HMD”)), an electronic garment, an electronic bracelet, an electronic necklace, an electronic appcessory, an electronic tattoo, or a smart watch.

In some embodiments, the user terminal 200 includes a processor 202, a memory 204, and an I/O device 206 such as a keypad, a touch screen, function buttons, a mini qwerty board, or any other type of input device capable of providing control of the user terminal 200, or any combination thereof. In some embodiments, the I/O device 206 also includes a speaker for outputting sound, and a microphone for detecting sound.

In some embodiments, the user terminal 200 also includes a display 208 such as a color LCD display, a touch screen display, or any combination thereof. In some embodiments, one or more of the I/O devices 206 displayed within a display 208 have touch screen capabilities, such as selectable GUI elements that are used to control features, functions, or various other applications of the user terminal 200.

In this manner, the user terminal 200 is configured to use the mobile device and numerous applications that output graphical elements configurable to control the mobile device 200 and applications accessible by the user terminal 200.

Furthermore, in some embodiments, the user terminal 200 also includes a shower system management application 210 that is accessible to the processor 202 and configured to enable the user to manage the use of the shower control system using the system management application 210 (e.g., using mobile communication).

In some embodiments, the user terminal 200 also includes a GPS module 212 such as GPS technology, cell tower location technology, triangulation technology, or any combination thereof. In some embodiments, the GPS module 212 is located within the user terminal 200. However, in other instances, a wireless network includes functionality that can be selectively accessed to detect a location of the user terminal 200.

Furthermore, in some embodiments, the user terminal 200 also includes a network interface 214 configurable to enable access to a WI-FI device 216, a Bluetooth device 218, a Zigbee device 220, or any combinations thereof. Alternatively or in addition, the user terminal 200 also includes a wireless data network device 222 including at least one radio frequency (RF) wireless communicator connected to at least one wireless network such as a 3G network, 4G network, a PCS network, an EDGE network, a cellular network, or any combination thereof.

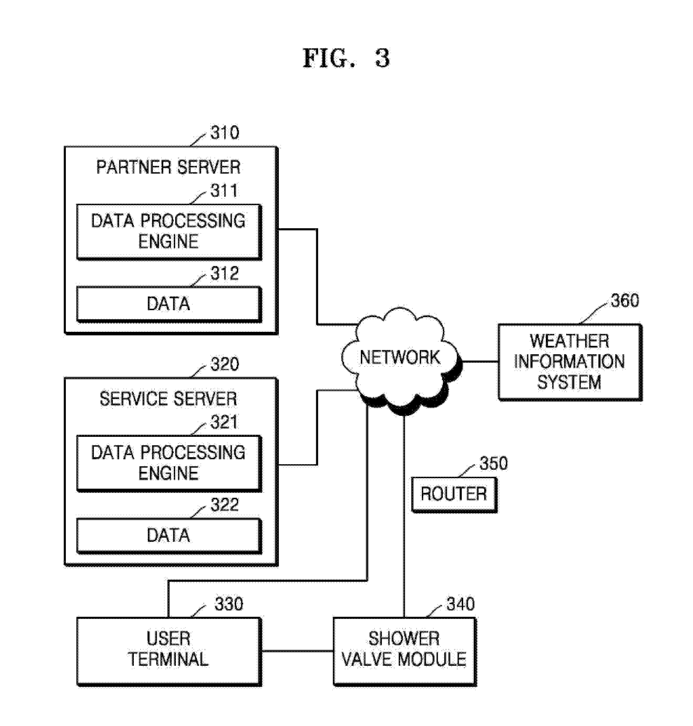

FIG. 3 schematically illustrates the shower system, including the shower control system, in terms of a network according to some embodiments.

In some embodiments, a partner server 310, a service server 320, a weather information system 360, a user terminal 330, and a shower valve module 340 are configured to transmit and receive data reciprocally via the network.

The partner server 310 refers to a server that collects and processes data for systems other than the shower control system. As an example, a server that collects or processes data from a device or system associated with a smart home or smart building is the partner server. Alternatively, in another example, a server of a government or public entity that communicates with an external system to transmit and receive data is also an example of the partner server.

In such an environment, the service server 320 receives: (i) information on the operational history of the shower control system from the shower valve module 340 and/or the user terminal 330; (ii) information related to another device or system from the partner server 310; and (iii) information related to the weather from the weather information system. Furthermore, the service server 320 analyzes the received information to generate data related to driving of the shower valve module, and transmits the generated data to the shower valve module 340 or the user terminal 330.

In some embodiments, the data that is transmitted from the service server 320 and related to the driving of the shower valve module 340 includes a scheduled shower pattern or shower recipe, recommended shower start information, and the like.

Meanwhile, as described above, the shower valve module 340 is connected to the network through the router 350. The routers 350 correspond to a smart home hub, a wireless router, etc.

The partner server 310 includes a data processing engine 311 and data 312. The data of the partner server 310 includes information collected from the device or system related to the partner server 310, or processed information generated from the collected information.

The data processing engine 311 generates new information based on the information collected from the device or system related to the partner server 310. In some embodiments, the data processing engine 311 generates additional new information based on the new information that is previously generated.

The service server 320 includes a data processing engine 321 and data 322. The data 322 of the service server 320 includes information collected from the device or system related to the service server 320 or processed information generated from the collected information.

The data processing engine 321 generates new information based on the information collected from the device or system related to the service server. In some embodiments, the data processing engine 321 generates additional new information based on the new information that is previously generated.

In such an environment, the shower valve module 340 receives user information and/or external information from the user terminal 330 or the service server 320 without an additional input interface device.

In some embodiments, the user information includes at least one of gender, age, race, an area, and a residential type. In addition, the external information includes at least one of current weather, a season, a date, an external temperature, a current time, user information of the surrounding area, and shower system operation information of the surrounding area.

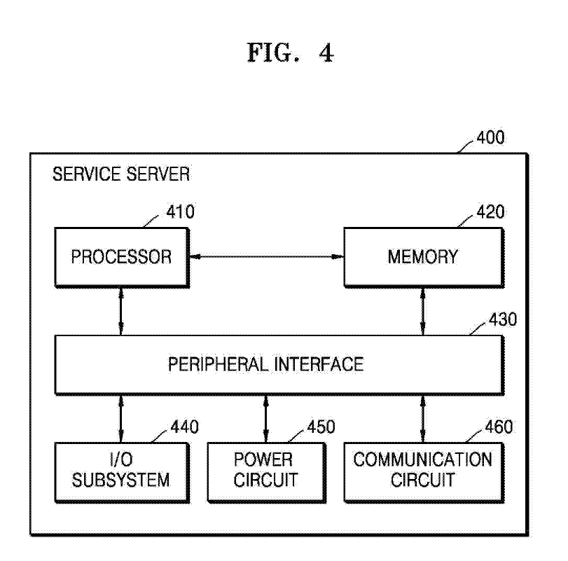

FIG. 4 schematically illustrates a configuration of a service server according to some embodiments.

As shown in FIG. 4, the service server 400 at least includes at least one processor 410, a memory 420, a peripheral interface 430, an I/O subsystem 440, a power circuit 450, and a communication circuit 460.

The memory 420 includes, for example, a high-speed random access memory, a magnetic disk, an SRAM, a DRAM, a ROM, a flash memory, or a non-volatile memory. In some embodiments, the memory 420 includes a software module, a set of instructions, or various other data necessary for the operation of the service server 400.

In some embodiments, access to the memory 420 from other components such as the processor 410 or the peripheral interface 430 is controlled by the processor 410.

In some embodiments, the peripheral interface 430 couples an input and/or output peripheral device of the service server 400 to the processor 410 and the memory 420. The processor 410 performs various functions for the service server 400 and processes data by executing the software module or the set of instructions stored in the memory 420.

In some embodiments, the I/O subsystem 440 couples various I/O peripheral devices to the peripheral interface 430. For example, I/O subsystem 440 includes a controller for coupling a peripheral device, such as a monitor, a keyboard, a mouse, a printer, or a touch screen or sensor as necessary, to the peripheral interface 430. In some embodiments, the I/O peripheral devices are coupled to the peripheral interface 430 without being connected to the I/O subsystem 440.

In some embodiments, the power circuit 450 supplies power to all or a part of components of the terminal. For example, the power circuit 450 includes a power management system, at least one power source such as a battery or an alternating current (AC), a charging system, a power failure detection circuit, a power converter or inverter, a power status indicator, or any other component for generating, managing, and distributing the power.

In some embodiments, the communication circuit 460 enables communication with other computing devices by using at least one external port.

Alternatively, in some embodiments, the communication circuit 460 includes an RF circuit for transmitting and receiving RF signals, which are also known as electromagnetic signals, to enable communication with other computing devices.

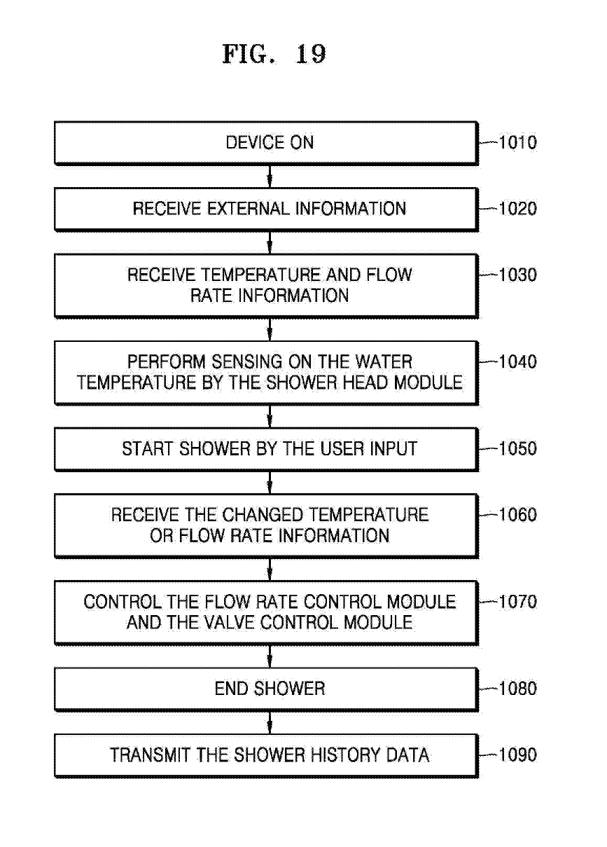

Such an embodiment shown in FIG. 4 is merely an example of the service server 400, and, in some embodiments, the service server 400 has a configuration or arrangement in which some components shown in FIG. 19 are omitted, additional components not shown in FIG. 19 are further included, or at least two components are coupled. The components included in the service server 400 are implemented in hardware, software, or a combination of both hardware and software, which include at least one integrated circuit specified for signal-processing or application.

### Hardware of the Shower Device

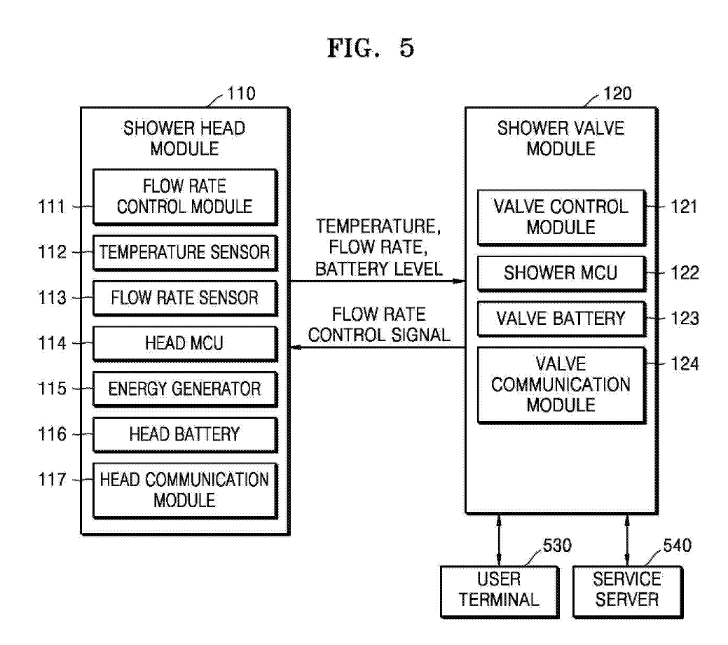

FIG. 5 schematically illustrates an electronic configuration of a shower head module 110 and a shower valve module 120 according to some embodiments.

FIG. 5 illustrates a configuration of the shower head module 110 (an example of a shower output assembly) and the shower valve module 120 (an example of a valve control assembly) in terms of electronic standpoint. In some embodiments, the shower head module 110 and the shower valve module 120 include additional electronic or mechanical components, depending on the circumstance.

As described above with reference to FIG. 1, the cold water and the hot water are supplied to the mixing valve, and the operation of the mixing valve is controlled by the shower valve module 120. The flow rate and/or temperature of the water supplied from the mixing valve is determined by the above-described control, and the water is supplied from the mixing valve to the user through the shower head module 110. In some embodiments, a shower head, typically adapted to the preference of the user, is coupled to the shower head module 110 for providing water. Alternatively, in some embodiments, the shower head module 110 includes a shower head (e.g., integrally formed or detachable).

In some embodiments, the shower head module 110 includes: a flow rate control module 111 for controlling a flow rate of water supplied to the shower head module 110 and discharged to the outside; a temperature sensor 112 for sensing a temperature of the water flowing inside the shower head module 110; a flow rate sensor 113 for sensing the flow rate of the water flowing inside the shower head module 110; an energy generator 115 for converting kinetic energy of the water flowing inside the shower head module 110 into electrical energy; a head battery 116 supplied with the electrical energy from the energy generator 115 to supply driving electric power for electrical components of the shower head module 110; a head communication module 117 (also referred to herein as a communications component 117) that communicates with the shower valve module 120; and a head MCU 114 (also referred to herein as an output controller) for controlling internal electrical components of the shower head module 110.

The flow rate control module 111 controls the flow rate of the water supplied to the shower head module 110 and discharged to the outside. In some embodiments, the flow rate control module 111 includes: an actuator; a power transfer unit for transferring power of the actuator; and an open-close member for opening and closing some flow paths among pipes inside the shower head module 110.

In some embodiments, the open-close member does not only close or open a water flow, but gradually close or open the water flow.

The temperature sensor 112 senses the temperature of the water flowing inside the shower head module 110. Preferably, the temperature sensor 112 is installed at a predetermined point in the pipes inside the shower head module 110, and temperature information of the water sensed by the temperature sensor 112 is transmitted to the shower valve module 120. According to the above configuration, the temperature is sensed on the shower head module 110, rather than on the shower valve module 120, so that information on the temperature closest to an actual temperature felt by the user is transmitted to the shower valve module 120. In this way, the shower valve module 120 and other systems that communicate with the shower valve module 120 analyze the shower history and generate new data based on this more accurate information.

The flow rate sensor 113 senses the flow rate of the water flowing inside the shower head module 110. The flow rate sensor 113 is installed, preferably, in an outlet side pipe of the flow rate control module 111, and the flow rate information of the water sensed by the flow rate sensor 113 is transmitted to the shower valve module 120. According to the above configuration, the flow rate is sensed on the shower head module 110, rather than on the shower valve module 120, so that information on the flow rate closest to an actual flow rate felt by the user is transmitted to the shower valve module 120. In this way, the shower valve module 120 and other systems that communicate with the shower valve module 120 analyze the shower history and generate new data based on this more accurate information.

In some embodiments, the information on the flow rate sensed by the flow rate sensor 113 is transmitted to the head MCU, and the head MCU generates a control signal for the flow rate control module 111 based on: (i) the information on the flow rate sensed by the flow rate sensor 113, and (ii) information on a desired flow rate received from the shower valve module 120. The control signal of the flow rate control module 111 is created by the feedback control known by those skilled in the art.

The energy generator 115 converts the kinetic energy of the water flowing inside the shower head module 110 into the electrical energy. In some embodiments, the head communication module 117 communicates with the shower valve module 120 through the low-power wireless communication. In instances where an operation load of the head MCU is not high, and power consumed by the temperature sensor 112 and the flow rate control module 111 is not large, the energy generator 115 alone is able to supply the power necessary for the electronic components inside the shower head module 110.

In some embodiments, the head MCU 114 monitors a battery charging level of the head battery 116, and opens the flow rate control module 111 when the battery charging level is determined to be lower than a preset reference value (e.g., lower than a predefined threshold value). In this case, even if the head battery 116 is completely discharged, the shower head module 110 is primarily opened to supply the user with water.

The head battery 116 receives the electrical energy from the energy generator 115, and supplies driving electric power to the electrical components of the shower head module 110. In some embodiments, the head battery 116 is a rechargeable battery, such as a Ni—Cd or Ni-MH based battery.

The head communication module 117 (also referred to herein as a communications component) communicates with the shower valve module 120. The head communication module 117 communicates in a wired and/or wireless manner, and preferably, in the wireless manner (e.g., using a short-wave communication signal, as noted below). In some embodiments, the head communication module 117 performs IEEE 802.15-based wireless communication, Zigbee communication, INSETEON communication, X10 communication protocol, Z-Wave communication, Bluetooth communication, WI-FI communication, IEEE 802.11-based communication, WiMAX communication, IEEE 802.16-based communication, and more preferably, communication in a low-power Bluetooth (BLE) manner.

The head MCU 114 serves to control the electronic components inside the shower head module 110. In some embodiments, the head MCU 114 receives data from the shower valve module 120, the temperature sensor 112, the flow rate sensor 113, the flow rate control module 111, the energy generator 115, the head communication module 117, and the head battery 116, generates a control signal based on the received data, and transmits the data to the flow rate control module 111, the energy generator 115, and the head communication module 117.

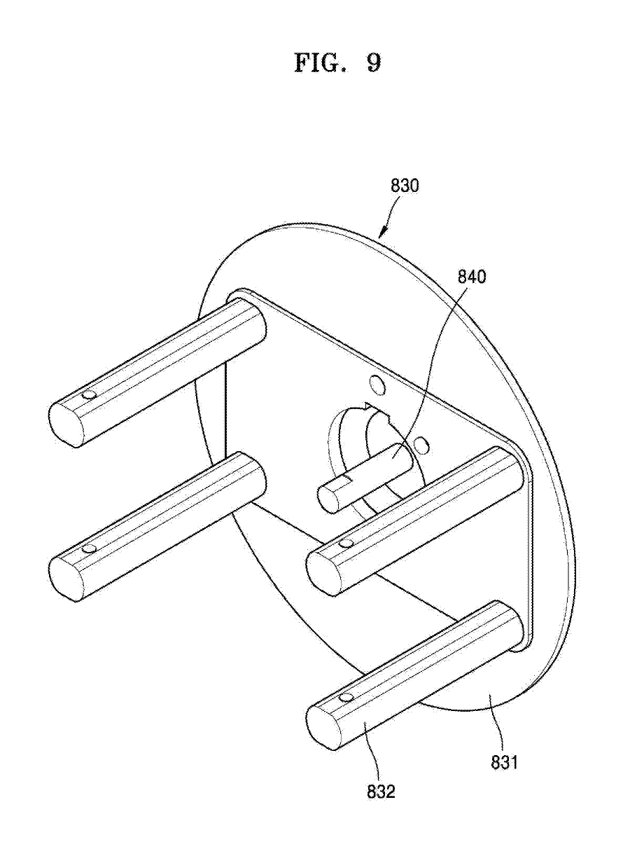

In some embodiments, the shower valve module 120 includes: a valve control module 121 for controlling a valve shaft (e.g., mixing shaft 840, FIG. 9) of a mixing valve; a valve battery 123 for supplying power to electronic components of the shower valve module 120; a valve communication module 124 that communicates with a shower head module 110, a user terminal, a service server; and a shower MCU 122 (also referred to herein as a valve controller) for generating a control signal for internal electronic components of the shower valve module 120 to control the internal electronic components.

In addition, although not shown, the shower valve module 120 further includes, in some embodiments, a control panel for receiving inputs directly from the user. Furthermore, in some embodiment, the shower valve module 120 also includes a display panel for displaying to the user at least one piece of information, including a shower temperature, a flow rate, a recipe, a schedule, and/or status of the shower control system.

The valve control module 121 controls the valve shaft of the mixing valve. Specifically, the valve control module 121 includes an actuator and a torque transfer unit, and the torque transfer unit is coupled with the valve shaft of the mixing valve, so that the valve control module 121 controls the mixing valve.

In some embodiments, the control signal related to the operation of the valve control module 121 is received from the shower MCU 122, and feedback control and the like are applied to the operation of the valve control module 121.

The valve battery 123 supplies power to the electronic components of the shower valve module 120. Preferably, the valve battery 123 corresponds to a rechargeable battery that is detachable from the shower valve module 120. In this arrangement, the user can remove the valve battery 123 from the shower valve module 120, charge the valve battery 123, and re-mount the valve battery 123 on the shower valve module 120 again.

In some embodiments, the valve communication module 124 (also referred to herein as a communications component) communicates with the shower head module 110, the user terminal, and the service server. In some embodiments, the valve communication module 124 includes at least two communication modules. Preferably, the valve communication module 124 includes a first valve communication module 124 for communicating with the shower head module 110, and a second valve communication module 124 for communicating with the user terminal, the service server, or a router for accessing the service server. More preferably, the first valve communication module 124 requires less power than the second valve communication module 124. For example, the first valve communication module 124 includes a BLE communication module, and the second valve communication module 124 includes a WI-FI communication module, or some other communication protocol noted above.

In some embodiments, the shower MCU 122 generates the control signal for the valve communication module 124 and the internal electronic components of the shower valve module 120 to control the internal electronic components. Preferably, the shower MCU 122 receives information on a sensing temperature sensed by the temperature sensor 112 of the shower head module 110, and then generates the control signal for the valve control module 121 based on a current desired temperature and the sensing temperature.

In some embodiments, the shower MCU 122 generates the control signal for the valve control module 121, based on the operation of the mixing valve learned, in addition to the desired temperature and the sensing temperature, and a reaction rate of the temperature sensed by the temperature sensor 112 of the shower head module 110.

In some embodiments, the shower MCU 122 measures the reaction rate of the temperature sensor 112 according to the operation of the valve control module 121, and learns the measured reaction rate, so as to correct an operation range of the valve control module 121 to compensate for a difference between the desired temperature and the sensing temperature. The learning of the reaction rate is performed by: (i) extracting a statistical representative value of a plurality of measured reaction rates, for example, an average value, a mode value, an intermediate value and the like, (ii) deriving a compensation value by performing a linear or non-linear numerical function process on the extracted representative value, and (iii) using the derived compensation value to correct the operation range of the valve control module 121. Alternatively, in some embodiments, a category among preset reaction rate categories, to which the corresponding shower control system belongs, is determined according to the representative value, and based on a preset compensation value that matches the category, the shower MCU 122 corrects the operation range of the valve control module 121.

In the above structure, the shower head module 110 and the shower valve module 120 transmit and receive data with each other. In some embodiments, the shower head module 110 transmits information that includes at least one of a temperature, a flow rate, and a battery level to the shower valve module 120, and the shower valve module 120 transmits information on the flow rate control performed in the flow rate control unit 111.

As noted above, the shower head module 110 uses a minimal amount of electric power and generates driving electric power in the energy generator 115 of the shower head module 110 so as to be driven by the electric power generated by itself. In addition, the operation processing, which uses more electric power and the mechanical driving by an electromagnetic actuator, are performed in the shower valve module 120. This arrangement allows the user to detach only the valve battery 123 mounted in the shower valve module 120 to perform charging, thereby improving the convenience of the user.

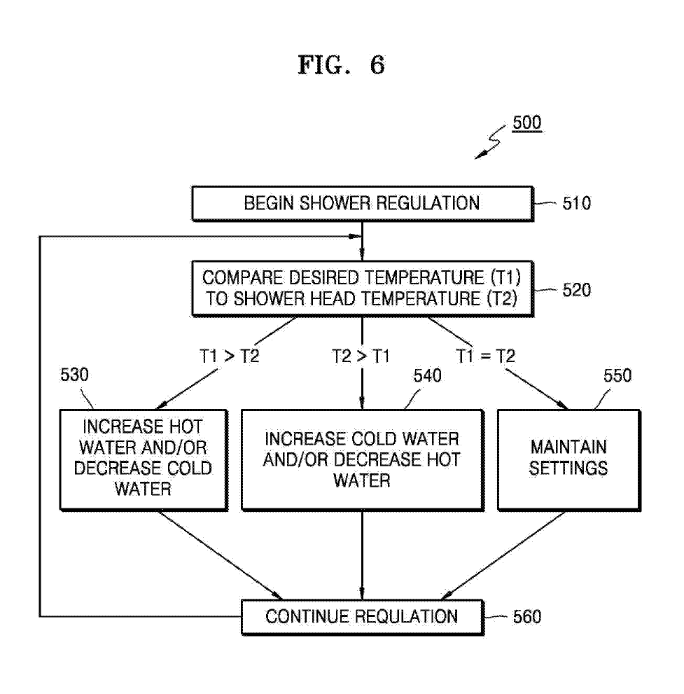

FIG. 6 illustrates a flowchart of a temperature control operation in the shower control system according to some embodiments.

In some embodiments, the temperature adjustment operation shown in FIG. 6 is performed in the shower MCU (also referred to herein as the valve controller) described above.

In step 510, the shower control system begins by adjusting the water temperature. In some embodiments, the water temperature adjustment is initiated by pressing an “ON” button via a user interface or a user device. In some embodiments, the shower control system initiates the water temperature adjustment based on other data, for example, an alarm clock setting in which the shower adjustment is actuated at a particular programmed time. In some embodiments, the shower control system sets a desired water temperature T1. In some embodiments, T1 is set directly by the user. In some embodiments, T1 is set based on profile data or other data.

In step 520, the shower control system receives a water temperature T2 read from the shower head module 110. The shower control system compares T1 to T2. An operational flow of the shower control system proceeds according to a result of the comparison.

If T1 is sufficiently higher than T2 (e.g., satisfies a predefined threshold difference), step 530 is performed. In step 530, the shower control system increases a flow of hot water or reduces a flow of cold water. For example, the shower control system automatically rotates a shower valve in a proper direction by using a motor of a shower valve controller.

If T1 is sufficiently lower than T2 (e.g., satisfies another threshold difference), step 540 is performed. In step 540, the shower control system reduces the flow of hot water or increases the flow of cold water. For example, the shower control system automatically rotates the shower valve in a proper direction by using the motor of the shower valve controller.

Alternatively, if T1 is equal to or sufficiently close to T2, step 550 is performed. In step 550, the shower control system maintains the water temperature. For example, the shower control system stops further rotation of the shower valve. In some embodiments, the shower control system combines a WFCS of the shower head to maintain the desired temperature in the valve while stopping the flow of water from the shower head. In some embodiments, the shower control system informs the user that an appropriate temperature has been reached (e.g., through the user terminal). In some instances, the user releases the WFCS to restart the flow of water from the shower head.

In step 560, the shower control system continues to adjust the water temperature. For example, the shower control system restarts step 520 with an uploaded water temperature measurement value. In some embodiments, the shower control system performs steps 520 to 560 in a feedback manner to maintain the desired water temperature during the shower.

In some embodiments, steps 520 to 560 are improved in various ways to improve the shower experience of the user. In some embodiments, the shower control system changes the feedback loop based on a previously-performed calibration. For example, during step 530 or step 540, the shower control system rotates the valve variously based on the relation between previously-defined rotation of the valve and an expected temperature change. In some embodiments, the shower control system changes the feedback loop based on other elements or data. For example, the feedback loop is changed based on time of a day, day of a week, outside temperature, calendar information, how much the hot water remains in a hot water heater, or other contextual information, or a combination thereof.

In some embodiments, the shower control system changes each aspect of the feedback loop. For example, the shower control system changes the feedback loop by changing how much the valve rotates in steps 530 and 540, how often a feedback cycle is repeated, the sensitivity to the comparison in step 520, another aspect of the feedback cycle, a combination thereof. In some embodiments, the feedback cycle is changed such that the water temperature reaches the desired temperature as soon as possible, or is changed such that the desired temperature remains constant.

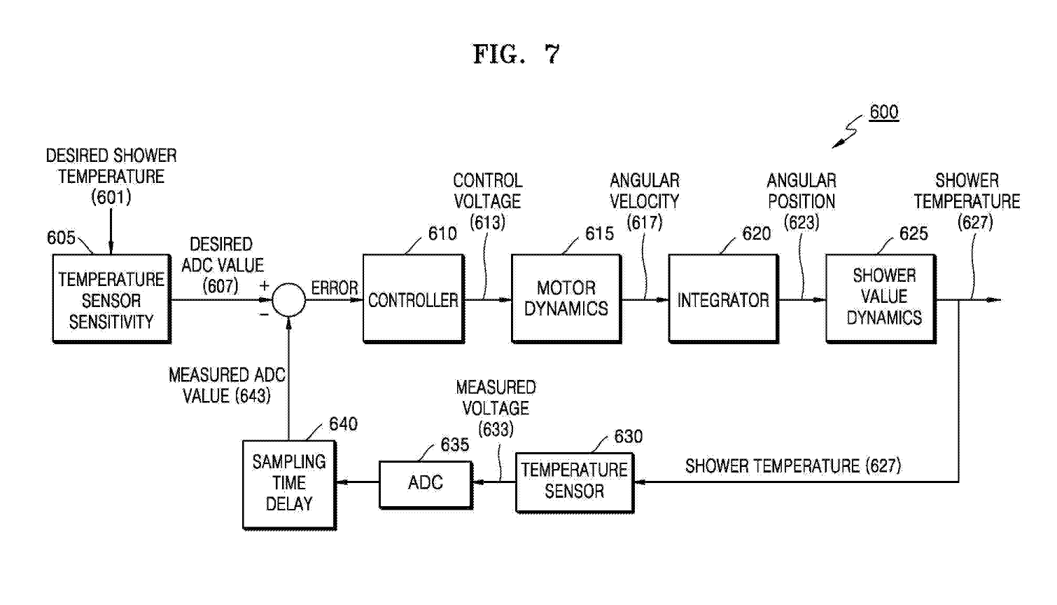

FIG. 7 illustrates a flowchart of a control operation in the shower control system according to some embodiments.

In some embodiments, the flowchart shown in FIG. 7 is performed in at least one of the valve control module 121 and the shower MCU 122 described with reference to FIG. 5, and preferably, in the shower MCU 122 (also referred to herein as the valve controller).

In some embodiments, a temperature sensor sensitivity controller 605 receives a desired shower temperature 601. The temperature sensor sensitivity controller 605 converts the desired shower temperature 601 to a desired analog-to-digital converter (ADC) value 607. The desired ADC value 607 is then compared to a measured ADC value 643. If the comparison fails, an appropriate error message is sent to a controller 610. In some embodiments, the controller 610 generates and outputs a control voltage 613. In some embodiments, the control voltage 613 is received by a direct current (DC) motor dynamic controller 615. The DC motor dynamic controller 615 outputs an angular velocity 617 to an integrator 620. The integrator 620 determines an angular position of the valve, and transmits the angular position to a shower valve dynamic controller 625. The shower valve dynamic controller 625 operates the motor to move the valve to a desired angular position. A new position of the valve leads to a new shower temperature 627.

In some embodiments, the shower temperature 627 is measured by a temperature sensor 630. An output of the temperature sensor 630 is converted into a digital form by an ADC 635. After a sampling delay 640, the measured ADC value 643 is generated to be compared with the desired ADC value 607. In some embodiments, the steps described above are modified according to a timing of the day, a date of the week, the outside temperature, the calendar information, how much hot water is left in the hot water heater, other contextual information, or a combination thereof.

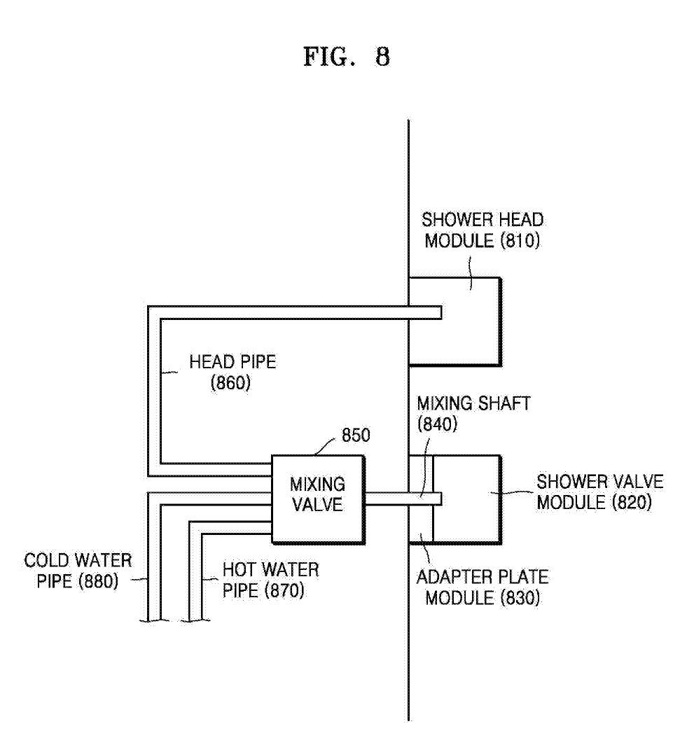

FIG. 8 schematically illustrates an installation configuration of the shower control system according to some embodiments.

In the embodiment shown in FIG. 8, an adapter plate module 830 (also referred to herein as a wall adapter assembly), a shower valve module 820, and a shower head module 810 are installed in a water supply system where a ratio of the cold water and the hot water is adjusted by one mixing shaft 840 (also referred to herein as a valve shaft) in one direction to determine the temperature and the flow rate. However, in some embodiments, the water supply system includes a mixing shaft 840 or at least two mixing shafts 840 that operate in at least two directions.

A cold water pipe 880, a hot water pipe 870, a mixing valve 850, and a head pipe 860 shown at left side of FIG. 8 correspond to the water supply system installed in a building. A vertical line shown in FIG. 8 refers to a wall, typically the cold water pipe 880, the hot water pipe 870, the mixing valve 850, and the head pipe 860 are wholly or partially embedded inside the wall. Moreover, the mixing shaft 840 of the mixing valve 850 protrudes to the outside, and the mixing shaft 840 is adjusted directly or indirectly to determine the temperature and/or flow rate.

In some embodiments, the adapter plate module 830 serves to mount the shower valve module 820 onto the wall, to prevent the mixing shaft 840 from being exposed to the outside, and to partially support the mixing shaft 840 in order to further secure the coupling between the shower valve module 820 and the mixing shaft 840.

In some embodiments, the shower valve module 820 (also referred to herein as the valve control assembly) is coupled to the mixing shaft 840, and the mixing shaft 840 is automatically adjusted by the power transferred by an actuator 824 of the shower valve module 820. In this arrangement, internal valve elements of the mixing valve 850 are controlled such that the water is supplied to the head pipe 860 at the temperature and/or flow rate desired by the user.

In some embodiments, the shower head module 810 (also referred to herein as the shower output assembly) senses the temperature and/or flow rate of the water while supplying (e.g., discharging) the water from the head pipe 860 to the outside (e.g., a bath tub), and controls the temperature and/or flow rate of the water according to a control signal from the shower valve module 820. In some embodiments, the shower head module 810 controls only the flow rate of water so as to be operated at low power.

In some embodiments, the shower head module 810 and an adapter plate are connected in wired or wireless communication so that they can transmit and receive data to and from each other.

FIG. 9 schematically illustrates an adapter plate module according to some embodiments.

In some embodiments, the adapter plate module 830 includes a wall attachment unit 831 having a form of a plate that attaches to a wall surface, and at least one shower valve module coupling unit 832 protruding from the wall attachment unit 831.

The wall attachment unit 831 is formed therein with a through-hole (e.g., an opening), and, in some embodiments, the mixing shaft 840 is exposed to the outside by passing through the wall attachment unit 831 via the through-hole. Although not shown, the wall attachment unit 831 is provided on the rear side thereof with a fastening element (e.g., a mechanical fastener) that fastens to the wall surface.

In some embodiments, the shower valve module coupling unit 832 (also referred to herein as support members) has a rod shape extending and protruding from one surface of the wall attachment unit 831. As shown, in some embodiments, a plurality of shower valve module coupling units 832 are provided to provide more structural safety.

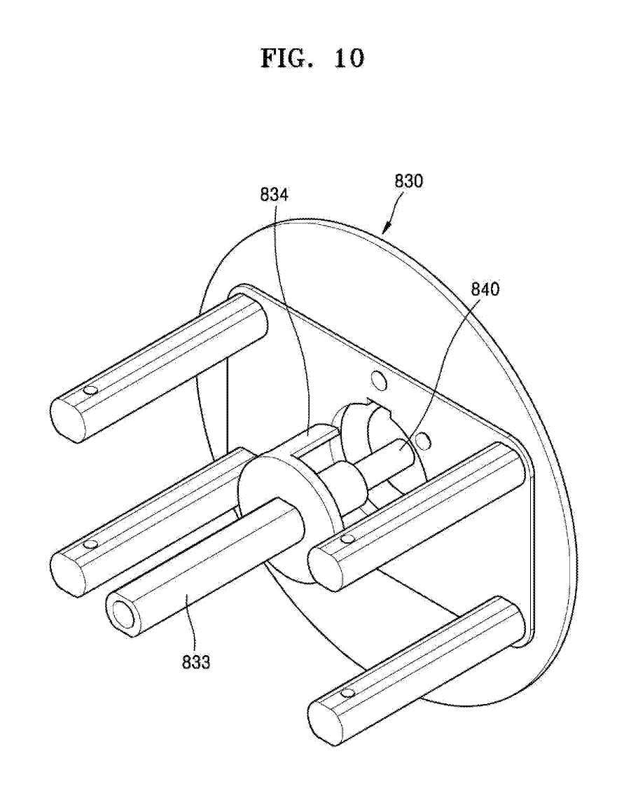

FIG. 10 schematically illustrates the adapter plate module according to some embodiments.

In some embodiments, the adapter plate module 830 includes a wall attachment unit 831 having a form of a plate that is attached to a wall surface, and at least one shower valve module coupling unit 832 protruding from the wall attachment unit 831.

The wall attachment unit 831 is formed therein with a through-hole, and, in some embodiments, the mixing shaft 840 is exposed to the outside by passing through the wall attachment unit 831 via the through-hole. Although not shown, the wall attachment unit 831 is provided on the rear side thereof with a fastening element (e.g., a mechanical fastener) that fastens to the wall surface.

In some embodiments, the shower valve module coupling unit 832 has a rod shape extending and protruding from one surface of the wall attachment unit 831. In some embodiments, a plurality of shower valve module coupling units 832 are provided to provide more structural safety.

In some embodiments, the adapter plate module 830 further includes a coupler 833 for coupling with the mixing shaft 840 and a support bracket 834 for fixing the coupler 833 to the wall surface (e.g., the support bracket 834 is disposed and/or secured within the opening defined in the wall attachment unit 831). In some embodiments, the coupler 833 is rotatably supported by the support bracket 834. In some embodiments, the opening defined in the wall attachment unit 831 includes a cutout (e.g., a groove) and a flange (e.g., a tongue) of the support bracket 834 is disposed in the cutout. In this way, the coupler 833 is rotatably supported by the support bracket 834.

In some embodiments, the coupler 833 has a shape of a pipe having a through-hole partially or entirely formed in the pipe, and one end of the mixing shaft 840 is coupled to the through-hole of the coupler 833, so that a position of the mixing shaft 840 changes according to the position change of the coupler 833. In some embodiments, the mixing shaft 840 has a degree of freedom for rotation about one axis. In some embodiment, the mixing shaft 840 has a degree of freedom for rotation and translation movement, so that the mixing shaft 840 can be manipulated in at least two forms.

In some embodiments, the support bracket 834 includes a bracket body formed therein with a through-hole for receiving the coupler 833, and a bracket leg extending and protruding from the bracket body. In some embodiments, the wall attachment unit 831 itself or a part of an outer circumferential surface of the through-hole inside the wall attachment unit 831 has a shape (e.g., a groove, a key slot, etc.) that engages with the bracket leg (e.g., a tongue, a corresponding key, etc.), for example, a perforation part or a concave part. Due to the above structure, the bracket leg is primarily mounted on the wall attachment unit 831, and the wall attachment unit 831 is mounted on the wall surface, so that the bracket leg is indirectly fixed to the wall surface.

In some embodiments, the coupler 833 is received in the through-hole of the bracket body. In such a structure, the coupler 833 is guided inside the through-hole of the bracket body, thereby rotating more stably. Even if the coupler 833 rotates by a motor operation of the shower valve module 820, eccentricity does not occur due to the above-described structure of the coupler 833. Accordingly, the rotation of the coupler 833 is accurately transferred to the mixing shaft 840.

In some embodiments, the coupler 833 is indirectly coupled to the actuator 824 inside the shower valve module 820 to receive power from the actuator 824, and to operate the mixing shaft 840 as a result.

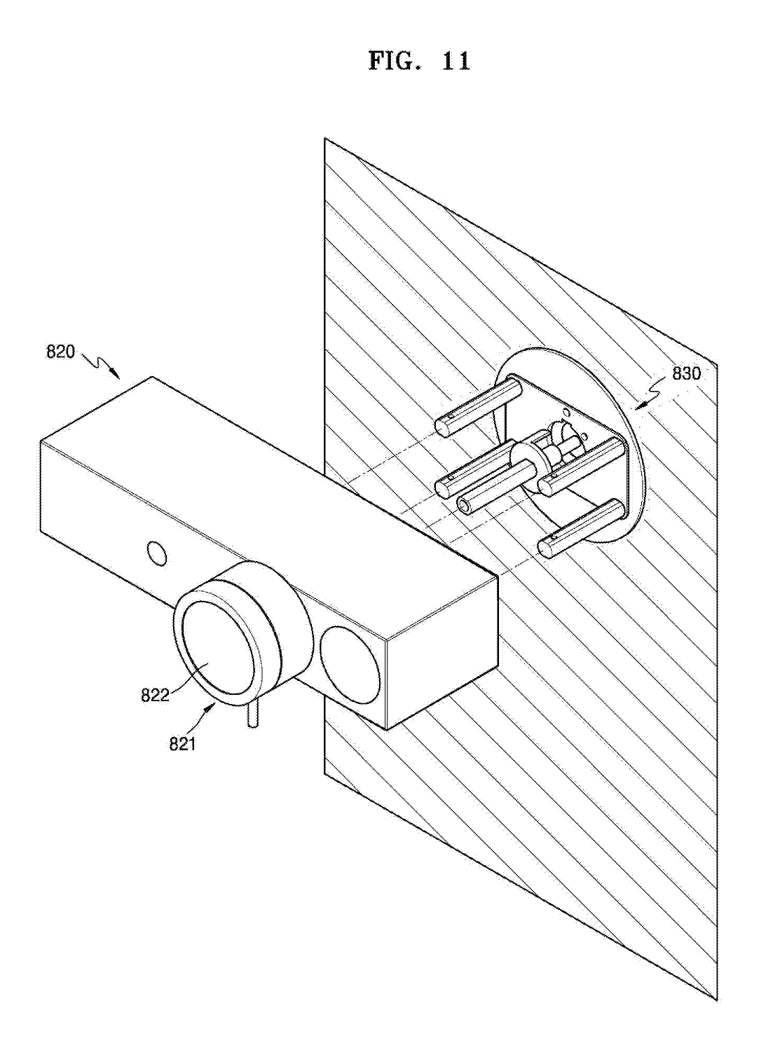

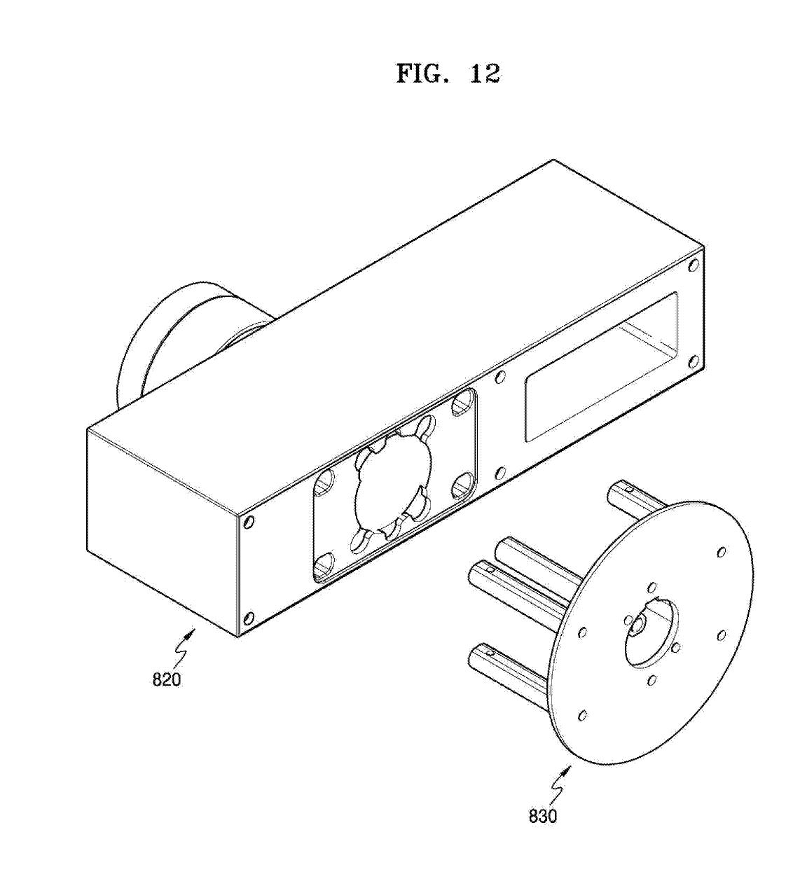

FIG. 11 schematically illustrates an installation configuration of the shower valve module 820 installed on a wall surface through the adapter plate module 830, when viewed from the front, according to some embodiments, and FIG. 12 schematically illustrates, when viewed from the back, a configuration of the shower valve module 820 coupled with the adapter plate module 830 according to some embodiments.

In some embodiments, as shown in FIGS. 11 and 12, the shower valve module coupling unit 832 of the adapter plate module 830 is fastened to a coupling hole on a rear surface of the shower valve module 820, and the shower plate module 820 is coupled to the adapter plate module 830 by the fastening. In addition, in some embodiments, a receiving part of the coupler 833 is received in a non-contact manner on the rear surface of the shower valve module 820. As such, the coupler 833 is coupled to the actuator 824 of the shower valve module 820 in the receiving part of the coupler 833 so that the coupler 833 can be rotated by the actuator 824 of the shower valve module 820.

In some embodiments, the shower valve module 820 is provided at a front surface thereof with a knob 821 operated by the user. As the user manually adjusts the knob 821, the coupler 833 is rotated, and the mixing shaft 840 is rotated by the rotation of the coupler 833. In addition, in some embodiments, the coupler 833 is automatically rotated by the actuator 824 inside the shower valve module 820 as well as the knob 821.

In some embodiments, when the user rotates the knob 821, the shower MCU of the shower valve module 820 receives information on the manual rotation of the knob 821, stops the operation of the actuator 824 inside the shower valve module 820, and allows the user to rotate the knob 821 without resistance. In some embodiments, a touch sensor is provided inside the knob 821 to recognize the touch of a user's hand, and the shower MCU stops the operation of the actuator 824 inside the shower valve module 820 depending on a sensing value of the touch sensor.

In some embodiments, the shower valve module 820 is provided at a front surface thereof with a display unit 822 that displays information related to the shower control system, for example, information on the temperature and flow rate. In some embodiments, the display unit 822 is provided on a front surface of the knob 821.

In some embodiments, the shower valve module 820 is further provided at a front surface thereof with a control panel that receives a user input. In some embodiments, the control panel is a button-type control panel or a ring-type control panel that rotates relatively to the knob 821 on the outer circumferential surface of the knob 821. With such control panels, the user is able to input the flow rate, the temperature, the recipe, or information related to other driving of the shower control system, and the shower valve module 820 and the shower head module 810 operates based on the inputted information.

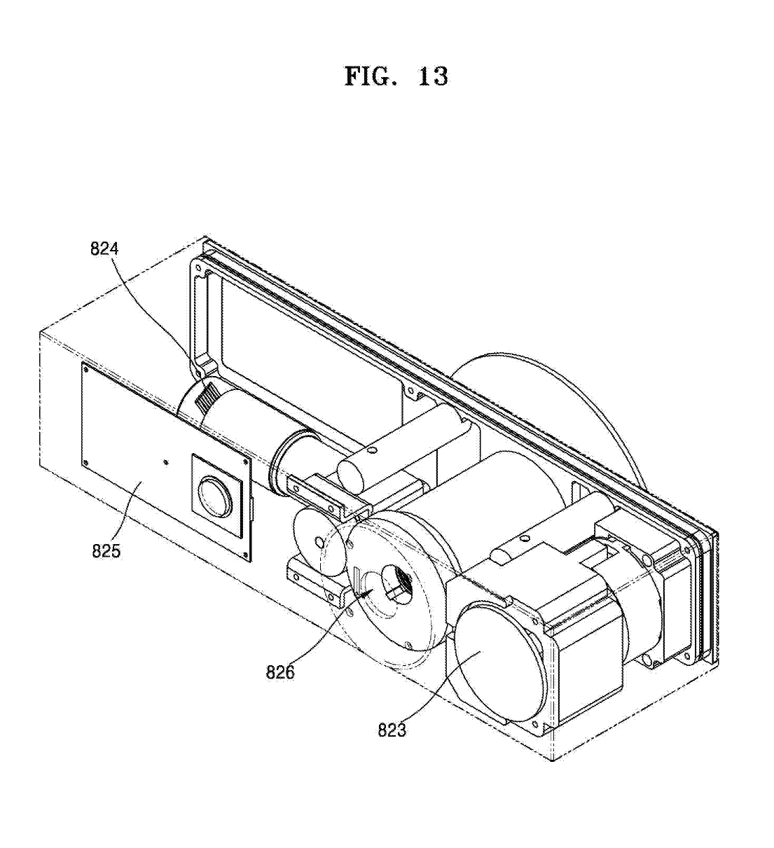

FIG. 13 schematically illustrates an internal structure of the shower valve module 820 according to some embodiments.

In some embodiments, the shower valve module 820 includes: a valve battery 823 that supplies power to an electronic configuration inside the shower valve module 820; an actuator 824 that provides operation power to a coupler 833 and/or a mixing shaft 840; a torque transfer assembly 826 for transferring the power generated by the actuator 824 to the coupler 833 and/or the mixing shaft 840; and a shower valve board 825 including an electronic circuit and/or a semiconductor.

In some embodiments, the shower MCU and the valve communication module, which are described with reference to FIG. 5, are included in the shower valve board 825. In addition, in some embodiments, the valve control module, which is described with reference to FIG. 5, includes the actuator 824.

In some embodiments, the shower MCU of the shower valve board 825 determines a desired temperature based on an input from a user terminal, an input to a control panel provided on the shower valve module 820, or a scheduled shower pattern received from the user terminal or a service server. Thereafter, as described with reference to FIGS. 6 and 7, the shower MCU of the shower valve board 825 generates an operation signal or a driving voltage of the actuator 824 to reduce a difference between an actual temperature received from the shower head module 810 and the desired temperature, and the operation signal is transmitted to the actuator 824, so that the actuator 824 transfers torque to a component that is directly engaged with the actuator 824 among components of the torque transfer assembly 826. The transferred torque is transferred to the mixing shaft 840 through the coupler 833, and the mixing valve 850 operates by the rotation of the mixing shaft 840.

In some embodiments, the actuator 824 includes a motor that is able to apply rotational torque. In addition, in some embodiments, the actuator further includes the motor and an internal torque transfer element that is able to convert a rotary axis of the motor. In some embodiments, the internal torque transfer element includes at least one of a worm gear, a spur gear, a helical gear, a bevel gear, and a rack/pinion gear.

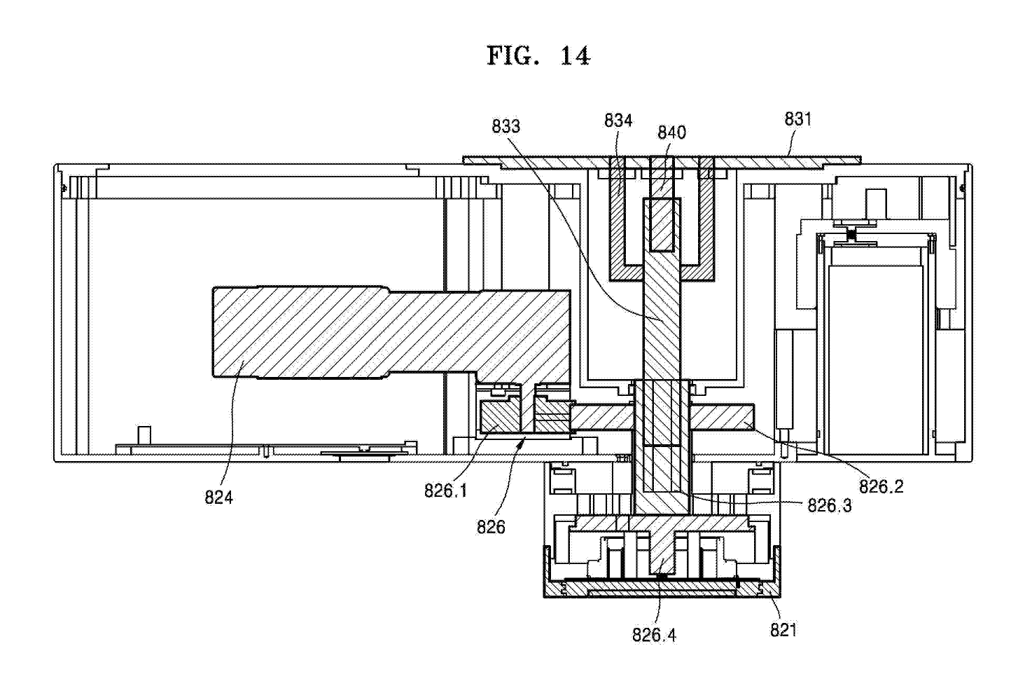

FIG. 14 schematically illustrates internal mechanical driving elements of the shower valve module 820 according to some embodiments.

In some embodiments, the actuator 824 includes a motor and an internal torque transfer element, and the rotary axis of the torque supplied from the actuator 824 is changed by 90 degrees by the internal torque transfer element. According to such an arrangement of the motor and the internal torque transfer element, the internal structure of the shower valve module 820 is used more efficiently.

In some embodiments, the torque transfer assembly 826 includes: an actuator gear 826.1 coupled to an output rotary shaft of the actuator 824; a coupler coupling part 826.3 coupled to the coupler 833 and having a rod shape formed therein with a through-hole; and a knob gear 826.2 coupled to an outer circumferential surface of the coupler coupling part 826.3. The knob gear 826.2 engages with the actuator gear 826.1. The torque of the actuator 824 is transferred to the coupler 833 through the actuator gear 826.1 and the knob gear 826.2, and the torque transferred to the coupler 833 is transferred to the mixing shaft 840, thereby controlling the mixing shaft 840. In some embodiments, the coupler coupling part 826.3 is directly coupled to the mixing shaft 840.

In some embodiments, the torque transfer assembly 826 further includes a knob coupling part 826.4. One end of the knob coupling part 826.4 is coupled to the knob 821, and the other end of the knob coupling part 826.4 is coupled to the coupler coupling part 826.3. Therefore, when the user rotates the knob 821, the torque applied to the knob 821 by the user is transferred to the knob coupling part 826.4. In some embodiments, the torque transferred to the knob coupling part 826.4 is transferred to the coupler coupling part 826.3, and the torque transferred to the coupler coupling part 826.3 is transferred to the mixing shaft 840 through the coupler 833.

In some embodiments, when the user manually rotates the knob 821, the shower MCU of the shower valve module 820 receives information on the manual rotation of the knob 821, stops the operation of the actuator 824 inside the shower valve module 820, and allows the user to rotate the knob 821 without resistance. In this case, when the user rotates the knob 821, the actuator 824 is also rotated. In some embodiments, the engagement of the actuator gear 826.1 with the knob gear 826.2 is released at the moment when it is recognized that the user is rotating the knob 821. Preferably, a touch sensor is provided inside the knob 821 to recognize the touch of a user's hand, and the shower MCU stops the operation of the actuator 824 inside the shower valve module 820 depending on a sensing value of the touch sensor.

In some embodiments, the coupler 833 has one end coupled to the mixing shaft 840 and the other end coupled to a coupling part of the coupler 833. In addition, the coupler 833 is rotatably supported by the support bracket 834 at a portion between the one end and the other end, and according to this configuration, the coupler 833 has an advantage that the torque generated by the actuator 824 or the operation performed on the knob 821 by the user can be stably transferred to the mixing shaft 840.

In some embodiments, the mixing shaft 840 is adjusted by manually manipulating the knob 821, even if the shower valve module 820 is not operated.

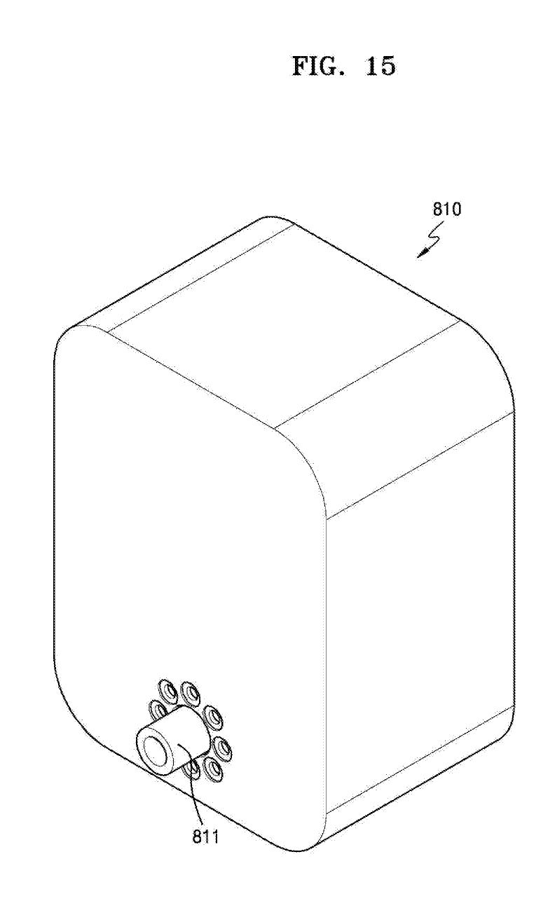

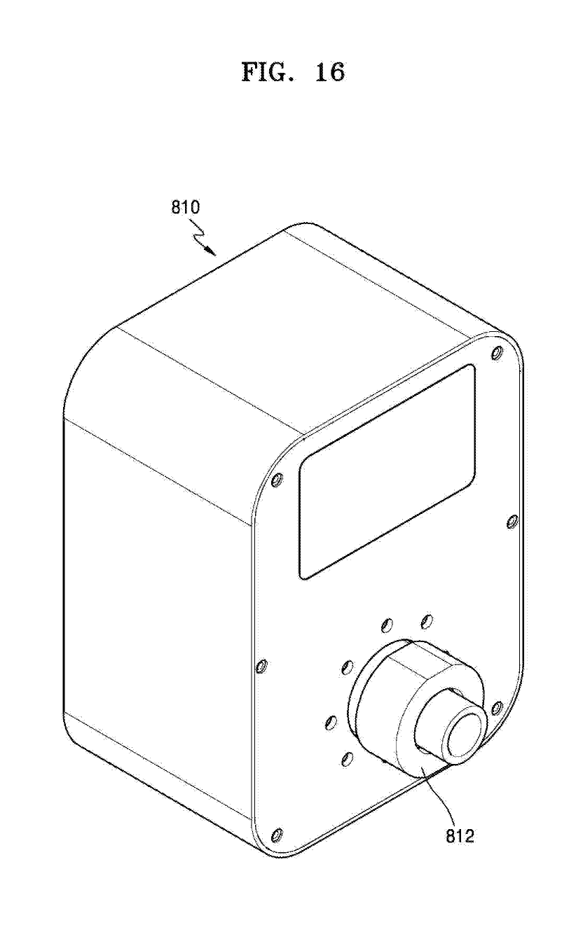

FIG. 15 is a front perspective view of the shower head module 810 according to some embodiments, and FIG. 16 is a rear perspective view of the shower head module 810 according to some embodiments.

In some embodiments, the shower head module 810 includes a shower head coupling part 811 on one side, and a head pipe coupling part 812 on the other side. The user uses the shower system by coupling the shower head adapted for the preference of the user to the shower head coupling part 811. The head pipe coupling part 812 is coupled to the head pipe 860 through which the water adjusted by the mixing valve 850 is supplied.

In some embodiments, the shower head module 810 controls the flow rate of water and senses the temperature of the water. Preferably, the shower head module 810 receives a control signal from the shower MCU of the shower valve module 820 to control the flow rate of water, and the temperature of the water sensed by the shower head module 810 is transmitted to the shower valve module 820 in the form of data.

In some embodiments, the desired temperature is determined by an input by the user terminal, a control panel input by the user, or data received from the service server, and the shower head coupling part 811 stops the flow of water until the temperature sensed inside the shower head coupling part 811 reaches the desired temperature. Thereafter, when the sensed temperature reaches the desired temperature, the flow of water in the shower head coupling part 811 is opened to immediately provide the user with the water having the desired temperature.

In some embodiments, when the shower MCU of the shower valve module 820 determines that the difference between the sensed temperature received from the shower head module 810 and the desired temperature is equal to or less than a preset difference, or determines that the sensed temperature and the desired temperature are substantially equal, a control signal for discharging the water is transmitted to the shower head module 810.

In some embodiments, when the shower MCU of the shower valve module 820 (the valve control assembly) determines that the difference between the sensed temperature received from the shower head module 810 (the shower output assembly) and the desired temperature is equal to or less than a preset difference, or determines that the sensed temperature and the desired temperature are substantially equal, and if there is a user input on the control panel of the user terminal or the shower valve module 820, the control signal for flowing the water is transmitted to the shower head module 810.

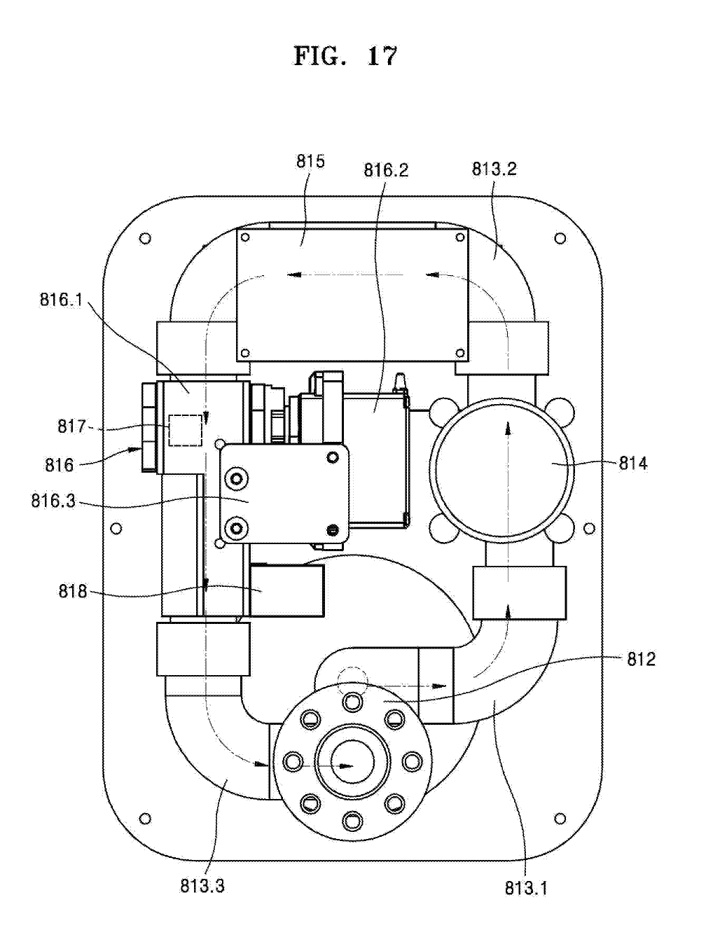

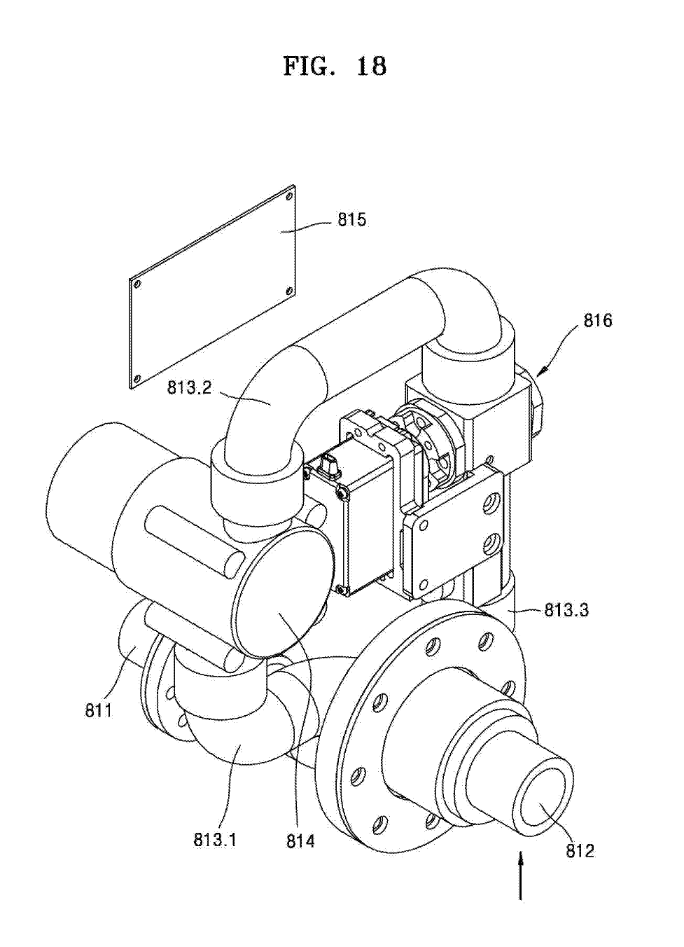

FIG. 17 schematically illustrates an internal configuration of the shower head module 810 according to some embodiments, and FIG. 18 is a perspective view illustrating the internal configuration of the shower head module 810 according to some embodiments.

In some embodiments, the shower head module 810 includes: a shower head coupling part 811 that couples to a shower head; a head pipe coupling part 812 that couples to a head pipe 860 through which water mixed by a mixing valve 850 is supplied; a pipe assembly; an energy generator 814 for generating electrical energy by water flowing inside the pipe assembly; a flow rate control module 816 for controlling a flow rate of the water flowing inside the pipe assembly; a temperature sensor 818 for directly or indirectly sensing a temperature of the water flowing inside the pipe assembly; a flow rate sensor 817 for sensing the flow rate of the water flowing inside the pipe assembly; and a head control board 815 that transmits and/or receives data to and/or from the flow rate control module 816, the temperature sensor 818, and the flow rate sensor 817, and is provided therein with at least one operational device and at least one memory.

Although not shown, the shower head module 810 further includes a head battery for supplying power to the electronic components inside the shower head module 810.

In some embodiments, the head communication module and the head MCU, which are described with reference to FIG. 5, are included in the head control board 815.

In some embodiments, the pipe assembly includes a first pipe 813.1 having one end coupled to the head pipe coupling part, a second pipe 813.2 coupled directly or indirectly to the first pipe 813.1, and a third pipe 813.3 coupled directly or indirectly to the second pipe 813.2.

In some embodiments, the water introduced into the head pipe coupling part 812 by the first pipe 813.1, the second pipe 813.2, and the third pipe 813.3 rotates substantially one turn, and is discharged to the shower head coupling part 811. In some embodiments, at least one of the first pipe 813.1, the second pipe 813.2, and the third pipe 813.3 includes at least one bent portion for changing a proceeding direction of a flow path, in which a sum of bending angles of the at least one bent portion is substantially 360 degrees. In such a structure, the shower head module 810 holds the water inside the shower head module 810 in a state that the flow having the flow rate is blocked by the flow rate control module 816 until the sensed temperature of the water sensed by the temperature sensor 818 is close (e.g., within a predefined threshold amount of degrees) to the desired temperature inputted to the shower valve module 820. In addition, according to such a structure, when the shower valve module 820 determines that the temperature sensed by the shower head module 810 is close to the desired temperature, and the shower head module 810 receives an open instruction for the flow rate control module 816 from the shower valve module 820, the flow rate control valve 816.1 is opened to supply the water to the user (e.g., servo motor 816.2, which operates under the control of the output controller, rotates the flow rate control valve 816.1). Herein, the term “substantial” signifies that an overall error range is within 5% to 10%. In some embodiments, a bracket 816.3 is used to secure the servo-motor 816.2 to the flow rate control valve 816.1.

In some embodiments, the first pipe 813.1 includes one bent portion substantially bent by 90 degrees, the second pipe 813.2 includes two bent portions substantially bent by 90 degrees, respectively, and the third pipe 813.3 includes one bent portion substantially bent by 90 degrees. In such a configuration, the water introduced into the head pipe coupling part 812 by the first pipe 813.1, the second pipe 813.2, and the third pipe 813.3 rotate substantially one turn, and is discharged to the shower head coupling part 811. Therefore, the shower head module 810 holds the water inside the shower head module 810 in a state that the flow having the flow rate is blocked by the flow rate control module 816 until the sensed temperature of the water sensed by the temperature sensor 818 is close to the desired temperature inputted to the shower valve module 820. In addition, according to such a structure, when the shower valve module 820 determines that the temperature sensed by the shower head module 810 is close to the desired temperature, and the shower head module 810 receives an open instruction for the flow rate control module 816 from the shower valve module 820, the flow rate control valve 816.1 is opened to supply the water to the user more stably.

In some embodiments, the energy generator 814 is disposed between the first pipe 813.1 and the second pipe 813.2, and the flow rate control module 816 is disposed between the second pipe 813.2 and the third pipe 813.3. In this structure, the mechanical energy of water is converted into the electrical energy with the highest energy efficiency, and the flow of water output to the outside of the shower head module 810 is controlled more precisely with the minimum power.

In some embodiments, the temperature sensor 818 directly or indirectly senses the temperature of the water flowing inside a module of the third pipe 813.3. According to this configuration, the temperature sensor 818 senses the temperature closest to the temperature of the water felt by the user.

FIG. 19 is a flowchart showing the operation of the shower system according to some embodiments.

In step 1010, the shower valve module, or the shower valve module and the shower head module are turned on by a direct input to the shower valve module by the user, an input by the user terminal, or an input from the service server.

In step 1020, external information is received by the shower MCU of the shower valve module or the user terminal. In some embodiments, the external information includes at least one of current weather, a season, a date, an external temperature, a current time, user information of the surrounding area, and shower system operation information of the surrounding area.

In step 1030, the desired temperature and/or flow rate information is received or determined by the shower MCU of the shower valve module or the user terminal.

In step 1040, the temperature sensor of the shower head module directly or indirectly senses the temperature of the water held in the pipe assembly inside the shower head module.

In step 1050, a shower is initiated by the direct input to the shower valve module by the user, the input by the user terminal, or the input from the service server. In detail, as the flow rate control module inside the shower head module is opened, the water is output from the shower head module.

In step 1060, the shower MCU receives or determines information on the changed temperature and/or flow rate by the direct input to the shower valve module by the user, the input by the user terminal, the input from the service server, or the shower recipe or shower pattern received by the shower valve module.

In step 1070, in some embodiments, the operations of the flow rate control module of the shower head module and/or the actuator of the shower valve module are controlled by the shower MCU.

In step 1080, the shower is terminated by the direct input to the shower valve module by the user, the input by the user terminal, the input from the service server, or the shower recipe or shower pattern received by the shower valve module, and accordingly, the flow rate control module of the shower head module stops the flow of water.

In step 1090, shower history data in the shower control system is transmitted to the user terminal or the service server. The shower history data includes information on the flow rate and/or temperature over time.

In light of these principles, we now turn to certain embodiments.

(A1) In accordance with some embodiments, the shower control system includes a valve control assembly (e.g., shower valve module 120, FIG. 1) configured to control one or more valves of a shower system (e.g., mixing valve 140, FIG. 1). Controlling the one or more valves adjusts a temperature of a water output for the shower system. The shower control system further includes a shower output assembly (e.g., shower head module 110, FIG. 1) having an inlet and an outlet. The shower output assembly is configured to: (i) receive, through the inlet, a water flow, and (ii) discharge, through the outlet, at least a portion of the water flow. The shower output assembly includes a temperature sensor (e.g., temperature sensor 112, FIG. 5) configured to determine a temperature of the received water flow or the discharged water flow.

(A2) In some embodiments of the shower control system of A1, the valve control assembly (e.g., shower head module 110, FIG. 1) is configured to couple to a valve assembly, of the shower system, that includes the one or more valves. In some embodiments, the valve assembly includes a single value. Alternatively, in some embodiments, the valve assembly includes multiple valves (e.g., a cold water valve and a hot water valve). In such case, at least in some embodiments, the valve control assembly includes components to operate each of the multiple valves (e.g., components to operate a cold water valve and components to operate a hot waver valve). Optionally, in some embodiments, the valve control assembly includes components to operate one of the multiple valves.

(A3) In some embodiments of the shower control system of any of A1-A2, the shower output assembly (e.g., shower valve module 120, FIG. 1) is configured to communicate (e.g., via communications component 117, FIG. 5) with the valve control assembly (via communications component 124, FIG. 5). The shower output assembly is configured to provide the determined temperature to the valve control assembly (e.g., the shower output assembly communicates the determined temperature to the valve control assembly). Furthermore, the valve control assembly is configured to control the one or more valves of the shower system based at least in part on the determined temperature.

(A4) In some embodiments of the shower control system of A3, the shower output assembly communicates with the valve control assembly using short-wave communication signals (e.g., communications protocols such as BLUETOOTH, WI-FI, ZIGBEE, etc.).

(A5) In some embodiments of the shower control system of any of A1-A4, the shower output assembly further includes an output controller (e.g., head MCU 114, FIG. 5) and the output controller is configured to adjust a flow rate of the discharged water flow.

(A6) In some embodiments of the shower control system of A5, the valve control assembly is configured to provide one or more control signals to the shower output assembly. Furthermore, the output controller is configured to adjust the flow rate of the discharged water flow based on the one or more control signals from the valve control assembly. For example, the output controller sets a first flow rate based on a first control signal received from the valve control assembly, sets to a second flow rate based on a second control signal received from the valve control assembly, and so on.

(A7) In some embodiments of the shower control system of A6, the shower output assembly further includes: (i) a pipe assembly; (ii) a battery for powering the output controller; and (iii) an energy generator, electrically coupled to the battery and disposed in the pipe assembly, configured to produce electricity from water flow inside the pipe assembly. The pipe assembly includes a first end (e.g., the inlet) and a second end (e.g., the outlet).

(A8) In some embodiments of the shower control system of any of A1-A7, the valve control assembly includes a valve controller (e.g., shower MCU 122, FIG. 5) and one or more actuators electrically coupled with the valve controller. A respective actuator of the one or more actuators is mechanically coupled with a valve shaft (e.g., mixing shaft 840, FIG. 8) of a respective rotary valve of the one or more valves. In some embodiments, the rotary valve is an example of the mixing valve 850 (FIG. 8). In this arrangement, the valve controller adjusts the temperature of the water output of the shower system by causing the respective actuator to rotate the coupled valve shaft.

(A9) In some embodiments of the shower control system of A8, the shower control system further comprises a wall adapter assembly (e.g., the adapter plate module 830, FIG. 9) for securing the valve control assembly (e.g., to a wall, to the one or more valves, and/or to the valve assembly). The wall adapter assembly includes: (i) a coupler mechanically coupled with the valve shaft; (ii) a support plate (e.g., the wall attachment unit 831, FIG. 9) with an opening to allow the valve shaft to mechanically couple (e.g., slidably couple) with the coupler; and (iii) a plurality of support members (e.g., the shower valve module coupling unit 832, FIG. 9) configured to receive and support the valve control assembly, extending away from the support plate. In some embodiments, one or more of the plurality of support members are substantially perpendicular to the support plate. As used herein, a support member is deemed to be substantially perpendicular to the support plate when the support member and a surface normal of the support plate forms an angle that is 45 degrees or less (e.g., 30 degrees or less, 20 degrees or less, 15 degrees or less, 10 degrees or less, etc.). In some embodiments, all of the plurality of support members are substantially perpendicular to the support plate.

(A10) In some embodiments of the shower control system of A9, the respective actuator is mechanically coupled with the valve shaft via a torque transfer assembly. The torque transfer assembly includes: (i) an actuator gear mechanically coupled to the respective actuator; (ii) a knob gear engaged with the actuator gear; and (iii) a coupler coupling part mechanically coupled to the knob gear and the coupler (e.g., as shown in FIG. 14, the coupler coupling part 826.3 is coupled to the coupler 833 and the knob coupling part 826.4). The respective actuator rotates the coupled valve shaft through the actuator gear and the knob gear.

(A11) In some embodiments of the shower control system of any of A9-A10, an end of the coupler is secured by a support bracket and the support bracket is disposed in the opening and is configured to rotatably support the end of the coupler.

(A12) In some embodiments of the shower control system of any of A9-A11, the coupler is pipe shaped having a hole extending at least partially into the end of the coupler (e.g., a through-hole) for placing the valve shaft in the hole.

(A13) In some embodiments of the shower control system of any of A8-A12, the valve controller is configured to cause the respective actuator to rotate the valve shaft in a first direction in accordance with determining that the determined temperature is less than a reference temperature (e.g., when the determined temperature is less than the reference temperature, the respective actuator rotates the valve shaft clockwise to increase the flow of hot water and/or decrease the flow of cold water, thereby increasing the temperature of the water output). Also, the valve controller is configured to cause the respective actuator to rotate the valve shaft in a second direction, that is opposite to the first direction, in accordance with determining that the determined temperature is greater than the reference temperature (e.g., when the determined temperature is greater than the reference temperature, the respective actuator rotates the valve shaft counterclockwise to decrease the flow of hot water and/or increase the flow of cold water, thereby decreasing the temperature of the water output). For example, the first direction is clockwise and the second direction is counterclockwise, or vice versa.

In some embodiments, when the valve assembly includes a first valve for hot water and a second valve for cold water, the valve controller is configured to adjust at least one of the first valve and the second valve in a first manner in accordance with determining that the determined temperature is less than the reference temperature (e.g., when the determined temperature is less than the reference temperature, a first actuator coupled with the first valve opens the first valve at least partially to increase the flow of hot water and/or a second actuator coupled with the second valve closes the second valve at least partially to decrease the flow of cold water, thereby increasing the temperature of the water output) and adjust the first valve and the second valve in a second manner distinct from the first manner in accordance with determining that the determined temperature is greater than the reference temperature (e.g., when the determined temperature is less than the reference temperature, the first actuator coupled with the first valve closes the first valve at least partially to decrease the flow of hot water and/or the second actuator coupled with the second valve opens the second valve at least partially to increase the flow of cold water, thereby decreasing the temperature of the water output).

(A14) In some embodiments of the shower control system of any of A8-A12, the valve controller is configured to cause the respective actuator to rotate the valve shaft in a first direction in accordance with determining that the determined temperature is below a first temperature threshold (e.g., the first temperature threshold corresponds to the reference temperature minus a temperature variation margin, such as 1, 2, 3, 4, or 5 degrees). Moreover, the valve controller is configured to cause the respective actuator to rotate the valve shaft in a second direction, that is opposite to the first direction, in accordance with determining that the determined temperature is above a second temperature threshold that is greater than the first temperature threshold (e.g., the second temperature threshold corresponds to the reference temperature plus the temperature variation margin). In addition, the valve controller is configured to forgo causing the respective actuator to rotate the valve shaft in the first direction or the second direction in accordance with determining that the determined temperature is above the first temperature threshold and below the second temperature threshold (e.g., the valve controller does not cause a rotation of the respective actuator when the difference between the determined temperature and the reference temperature is less than the temperature variation margin).

(A15) In some embodiments of the shower control system of any of A1-A14, the shower output assembly is configured to: (i) compare the determined temperature with a reference temperature; (ii) determine a difference between the determined temperature and the reference temperature; and (iii) communicate (e.g., via the communications component 117, FIG. 5) with the valve control assembly in response to determining that a difference between the determined temperature and the reference temperature satisfies a predefined threshold. For example, the communications component 117 of the shower output assembly sends a communication signal to the communications components 124 of the valve control assembly indicating the difference between the determined temperature and the reference temperature. In some embodiments, the comparing and the determining operations are performed by the output controller.

(A16) In some embodiments of the shower control system of any of A1-A14, the valve control assembly is configured to: (i) compare the determined temperature and a reference temperature; (ii) determine a difference between the determined temperature and the reference temperature; and (iii) adjust the temperature of the water output in response to determining that a difference between the determined temperature and the reference temperature satisfies a predefined threshold. For example, the valve control assembly adjusts the temperature of the water output (e.g., by adjusting one or more valves of the valve assembly) when the difference between the determined temperature and the reference temperature is greater than the predefined threshold. In some embodiments, the comparing and the determining operations are performed by the valve controller.

(A17) In some embodiments of the shower control system of any of A1-A16, the shower output assembly includes one or more processors and memory (e.g., the head MCU 114 and associated memory).

(A18) In some embodiments of the shower control system of any of A1-A17, the outlet of the shower output assembly is configured to mechanically couple with a shower head (e.g., the shower output assembly has a thread to which a shower head can be mounted).

(A19) In some embodiments of the shower control system of any of A1-A18, the shower output assembly is distinct and separate from the valve control assembly (e.g., the shower head module 110 and the shower valve module 120 in FIG. 5). In some embodiments, the shower output assembly is integrated with the valve control assembly.

(A20) In some embodiments of the shower control system of any of A1-A19, the valve control assembly includes one or more processors and memory (e.g., shower MCU and associated memory).

Although only a few exemplary embodiments have been described in detail with reference to the drawings, those skilled in the art will appreciate that various modifications and changes may be made from the above description. For example, appropriate results can be achieved even if the described technologies are performed in an order different from the described methods, and/or the described components such as systems, structures, devices, and circuits are coupled or combined in a manner different from the described methods, or substituted or replaced by other components or their equivalents. Therefore, other implementations, other embodiments, and equivalents of the claims are within the scope of the following claims.

What is claimed is:

1. A shower control system, comprising:
a valve control assembly configured to control one or more valves of a shower system, whereby controlling the one or more valves adjusts a temperature of a water output for the shower system; and
a shower output assembly having an inlet and an outlet, the shower output assembly configured to receive through the inlet a water flow and discharging through the outlet at least a portion of the water flow, wherein the shower output assembly includes a temperature sensor configured to determine a temperature of the received water flow or the discharged water flow.

2. The shower control system of claim 1, wherein:
the valve control assembly is configured to couple to a valve assembly, of the shower system, that includes the one or more valves.

3. The shower control system of claim 1, wherein:
the shower output assembly is configured to communicate with the valve control assembly, whereby the shower output assembly is configured to provide the determined temperature to the valve control assembly; and
the valve control assembly is configured to control the one or more valves of the shower system based at least in part on the determined temperature.

4. The shower control system of claim 3, wherein:
the shower output assembly communicates with the valve control assembly using short-wave communication signals.

5. The shower control system of claim 1, wherein:
the shower output assembly further comprises an output controller; and
the output controller is configured to adjust a flow rate of the discharged water flow.

6. The shower control system of claim 5, wherein:
the valve control assembly is configured to provide one or more control signals to the shower output assembly; and
the output controller is configured to adjust the flow rate of the discharged water flow based on the one or more control signals from the valve control assembly.

7. The shower control system of claim 6, wherein the shower output assembly further comprises:
a pipe assembly;
a battery for powering the output controller; and
an energy generator, electrically coupled to the battery and disposed in the pipe assembly, configured to produce electricity from water flow inside the pipe assembly.

8. The shower control system of claim 1, wherein:
the valve control assembly includes a valve controller and one or more actuators electrically coupled with the valve controller; and
a respective actuator of the one or more actuators is mechanically coupled with a valve shaft of a respective rotary valve of the one or more valves,
whereby the valve controller adjusts the temperature of the water output of the shower system by causing the respective actuator to rotate the coupled valve shaft.

9. The shower control system of claim 8, wherein the shower control system further comprises a wall adapter assembly for securing the valve control assembly to a wall, the wall adapter assembly comprising:
a coupler mechanically coupled with the valve shaft;
a support plate with an opening to allow the valve shaft to mechanically couple with the coupler; and
a plurality of support members, configured to receive and support the valve control assembly, extending away from and being substantially perpendicular to the support plate.

10. The shower control system of claim 9, wherein:
the respective actuator is mechanically coupled with the valve shaft via a torque transfer assembly; and
the torque transfer assembly comprises:
an actuator gear mechanically coupled to the respective actuator;
a knob gear engaged with the actuator gear; and
a coupler coupling part mechanically coupled to the knob gear and the coupler,
whereby the respective actuator rotates the coupled valve shaft through the actuator gear and the knob gear.

11. The shower control system of claim 9, wherein:
an end of the coupler is secured by a support bracket; and
the support bracket is disposed in the opening and is configured to rotatably support the end of the coupler.

12. The shower control system of claim 9, wherein:
the coupler is pipe shaped having a through-hole extending at least partially into the end of the coupler; and
the valve shaft is disposed in the through-hole.

13. The shower control system of claim 8, wherein:
the valve controller is configured to cause the respective actuator to rotate the valve shaft in a first direction in accordance with determining that the determined temperature is less than a reference temperature; and
the valve controller is configured to cause the respective actuator to rotate the valve shaft in a second direction, that is opposite to the first direction, in accordance with determining that the determined temperature is greater than the reference temperature.

14. The shower control system of claim 8, wherein:
the valve controller is configured to cause the respective actuator to rotate the valve shaft in a first direction in accordance with determining that the determined temperature is below a first temperature threshold;
the valve controller is configured to cause the respective actuator to rotate the valve shaft in a second direction, that is opposite to the first direction, in accordance with determining that the determined temperature is above a second temperature threshold that is greater than the first temperature threshold; and
the valve controller is configured to forgo causing the respective actuator to rotate the valve shaft in the first direction or the second direction in accordance with determining that the determined temperature is above the first temperature threshold and below the second temperature threshold.

15. The shower control system of claim 1, wherein:
the shower output assembly is configured to:
compare the determined temperature with a reference temperature;
determine a difference between the determined temperature and the reference temperature; and
communicate with the valve control assembly in response to determining that a difference between the determined temperature and the reference temperature satisfies a predefined threshold.

16. The shower control system of claim 1, wherein:
the valve control assembly is configured to:
compare the determined temperature and a reference temperature;
determine a difference between the determined temperature and the reference temperature; and
adjust the temperature of the water output in response to determining that a difference between the determined temperature and the reference temperature satisfies a predefined threshold.

17. The shower control system of claim 1, wherein:
the shower output assembly includes one or more processors and memory.

18. The shower control system of claim 1, wherein:
the outlet of the shower output assembly is configured to mechanically couple with a shower head.

19. The shower control system of claim 1, wherein:
the shower output assembly is distinct and separate from the valve control assembly.

20. The shower control system of claim 1, wherein:
the valve control assembly includes one or more processors and memory.
